(19) United States
(12) Patent Application Publication
(10) Pub. No.: US 2014/0293082 A1
(43) Pub. Date: Oct. 2, 2014

(54) IMAGE PROCESSING APPARATUS AND METHOD, AND PROGRAM

(71) Applicant: Sony Corporation, Tokyo (JP)

(72) Inventors: Akihiro OKUMURA, Kanagawa (JP); Ichiro FUJISAWA, Kanagawa (JP); Katsutoshi ANDO, Kanagawa (JP); Takashi TSUCHIYA, Tokyo (JP)

(73) Assignee: Sony Corporation, Tokyo (JP)

(21) Appl. No.: 14/220,303

(22) Filed: Mar. 20, 2014

(30) Foreign Application Priority Data
Mar. 29, 2013 (JP) 2013074578

(51) Int. Cl. G06T 3/40

(52) U.S. Cl. CPC G06T 3/4053; G06T 3/4015
USPC 348/222.1

(57) ABSTRACT

An image processing apparatus includes a color variation amount/normalized dynamic range operation unit that operates color variation amounts indicating variation amounts of a first color component and a second color component for a third color component of the plurality of color components in pixels of the designated region of a first image output from a single-plate type pixel portion, and a coefficient reading unit that reads a coefficient stored in advance on the basis of a result of class sorting of the designated region, in which an operation method of pixel values of the second image formed by pixels of only the first color component and an operation method of pixel values of the second image formed by pixels of only the second color component are changed on the basis of the color variation amounts and the normalized dynamic ranges.

### CROSS REFERENCE TO RELATED APPLICATIONS

This application claims the benefit of Japanese Priority Patent Application JP 2013-074578 filed Mar. 29, 2013, the entire contents of which are incorporated herein by reference.

### BACKGROUND

The present technology relates to an image processing apparatus and method, and a program, and particularly to an image processing apparatus and method, and a program, capable of obtaining an image signal of each color component from an output of an image sensor having a color filter array formed by a plurality of color components without deterioration in image quality.

Imaging apparatuses using an image sensor mainly includes a single-plate type apparatus (hereinafter, referred to as a single-plate type camera) using a single image sensor and a three-plate type apparatus camera (hereinafter, referred to as a three-plate type camera) using three image sensors.

In the three-plate type camera, for example, three image sensors for an R signal, a G signal, and a B signal, are used, and three primary color signals are obtained using the three image sensors. In addition, a color image signal generated from the three primary color signals is recorded onto a recording medium.

In the single-plate type camera, a single image sensor is used in which a color coding filter formed by an array of a color filter assigned to each pixel is provided on a front surface, and a color component signal which is color-coded by the color coding filter is obtained for each pixel. As a color filter array forming the color coding filter, primary color filter arrays of red (R), green (G), and blue (B), or complementary color filter arrays of yellow (Ye), cyanogen (Cy), and magenta (Mg) are used. In addition, in the single-plate type camera, a single color component signal is obtained for each pixel using the image sensor, and color signals other than a color component signal of each pixel are generated through a linear interpolation process, thereby obtaining an image close to an image obtained by the three-plate type camera. In a video camera and the like, the single-plate type is employed in order to achieve miniaturization and light weight.

A color filter array with the Bayer array is frequently used as a color filter array forming the color coding filter. In the Bayer array, G filters are disposed in a checkered pattern, and R and B filters are alternately disposed for each column in the remaining parts.

In this case, the image sensor outputs only an image signal corresponding to a color of a filter, from each pixel where one color filter of three primary colors of R, G and B is disposed. In other words, an R component image signal is output from a pixel in which the R filter is disposed, but G component and B component image signals are not output therefrom. Similarly, only a G component image signal is output from a G pixel, and R component and B component image signals are not output therefrom. Only a B component image signal is output from a B pixel, and R component and B component image signals are not output therefrom.

However, when the signal of each pixel is processed in a subsequent stage of an image process, R component, G component, and B component image signals are necessary for every pixel. Therefore, in the related art, n×m image signals of the R pixels, n×m (where n and m are positive integers) image signals of the G pixels, and n×m image signals of the B pixels are obtained from an output of the image sensor formed by n×m pixels through interpolation operations, respectively, and are output to the subsequent stage.

In addition, a technique has been proposed in which 2n×2m image signals of the R pixels are obtained from n×m image signals of the R pixels through an interpolation operation, 2n×2m image signals of the G pixels are obtained from n×m image signals of the G pixels through an interpolation operation, and 2n×2m image signals of the B pixels are obtained from n×m image signals of the B pixels through an interpolation operation (for example, Japanese Unexamined Patent Application Publication No. 2000-308079),

According to the technique of Japanese Unexamined Patent Application Publication No. 2000-308079, a pixel value of a target pixel of an output image is predicted through a product-sum operation using a coefficient which is obtained in advance through learning, by using a pixel corresponding to the target pixel in an input image and values of pixels around the pixel as variables. In this way, it is possible to generate a three-primary color signal equal to an image signal obtained by the three-plate type camera, from an output of an image sensor of the single-plate type camera.

### SUMMARY

However, in a case of Japanese Unexamined Patent Application Publication No. 2000-308079, pixel values respectively corresponding to R, G and B in the image sensor are used as taps which are variables of a predictive operation without change.

However, since each pixel value of R, G and B originally has low correlation, for example, even if a plurality of pixel values around a target pixel are input as taps, a sufficient effect is not achieved in the predictive operation. For example, pixel values are generated through the predictive operation in a region or the like where little correlation is observed in a variation in each pixel value of R, G and B, and there is a case where image quality deterioration such as a false color, color bleeding, or ringing notably occurs.

In addition, in the image sensor of the single-plate type camera, light incident to the image sensor is made to pass through an optical low-pass filter in order to prevent an influence of a false color, artifact, or the like.

However, if the light is made to pass through the optical low-pass filter as above, an image may be blurred.

In other words, in the technique of the related art, it may be difficult to obtain a three-primary color without causing image quality deterioration such as image blurring, a false color, color bleeding, or ringing in the single-plate type camera.

It is desirable to obtain an image signal of each color component from an output of an image sensor having a color filter array formed by a plurality of color components without deterioration in image quality.

According to an embodiment of the present technology, there is provided an image processing apparatus including a color variation amount/normalized dynamic range operation unit that selects a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component; a class sorting unit that performs class sorting on the designated region on the basis of a feature amount obtained from pixel values of the designated region; a coefficient reading unit that reads a coefficient stored in advance on the basis of a result of the class sorting; and a product-sum operation unit that uses a prediction tap including pixel values related to predetermined pixels of the designated region for the prediction tap as a variable, and operates pixel values of second images through a product-sum operation using the read coefficient, each of the second images being formed by pixels of only a single color component of the plurality of color components, in which an operation method of pixel values of the second image formed by pixels of only the first color component and an operation method of pixel values of the second image formed by pixels of only the second color component are changed on the basis of the color variation amounts and the normalized dynamic ranges.

In the image processing apparatus, a structure of the prediction tap may be changed on the basis of the color variation amounts and the normalized dynamic ranges.

The image processing apparatus may further include a representative value operation unit that operates a representative value of each of the color components in the designated region; and a color component conversion unit that converts pixel values of each color component of the prediction tap into conversion values which are obtained by offsetting the pixel values with respect to a pixel value of one of the plurality of color components, serving as a reference, by using the representative value, in which the product-sum operation unit uses the conversion values as variables, and operates pixel values of second images through a product-sum operation using the read coefficient, each of the second images being formed by pixels of only a single color component of the plurality of color components.

In the image processing apparatus, the single-plate type pixel portion may be a pixel portion with a Bayer array including R, G and B components. In addition, the representative value operation unit may calculate an interpolation value g of an R pixel or a B pixel on the basis of a G pixel around the R pixel or the B pixel; calculate an interpolation value r and an interpolation value b of the G pixel on the basis of the R pixel or the B pixel around the G pixel; operate a G representative value by using an average value of an input value G which is directly obtained from the G pixel and the interpolation value g; operate an R representative value on the basis of a difference between the interpolation value r and the input value G, a difference between an input value R which is directly obtained from the R pixel and the interpolation value g, and the G representative value; and operate a B representative value on the basis of a difference between the interpolation value b and the input value G, a difference between an input value B which is directly obtained from the B pixel and the interpolation value g, and the G representative value.

In the image processing apparatus, when the second image is formed by only the G pixel, the color component conversion unit may offset the input value R by a difference between the R representative value and the G representative value, and offset the input value B by a difference between the B representative value and the G representative value.

In the image processing apparatus, the color variation amount/normalized dynamic range operation unit may calculate a color variation amount Rv of an R component on the basis of a dynamic range of a difference value between the input value R and the interpolation value g of the R pixel; calculate a color variation amount Bv of a B component on the basis of a dynamic range of a difference value between the input value B and the interpolation value g of the B pixel; normalize a dynamic range of the input value R so as to calculate a normalized dynamic range NDR_R of the R component; normalize a dynamic range of the input value B so as to calculate a normalized dynamic range NDR_B of the B component; and normalize a dynamic range of the input value G so as to calculate a normalized dynamic range NDR_G of a G component.

In the image processing apparatus, when the second image formed by only the G component of the plurality of color components is generated, and the second image formed by only the R component and the second image formed by only the B component of the plurality of color components are generated, the prediction tap may be acquired from the second image formed by only the G component.

In the image processing apparatus, when the second image formed by only the R component is generated, any one of first to third modes may be selected by comparing the color variation amount Rv, the normalized dynamic range NDR_R, the normalized dynamic range NDR_G, and an absolute value of a difference value between the color variation amount Rv and the color variation amount Bv with threshold values, respectively. Here, in the first mode, a prediction tap including the input value R of the first image and pixel values of the second image formed by pixels of only the G component may be acquired; in the second mode, a prediction tap including only pixel values of the second image formed by pixels of only the G component may be acquired; and, in the third mode, a prediction tap including only the input value R of the first image may be acquired.

The image processing apparatus may further include a virtual color difference operation unit that operates a virtual color difference of the prediction tap. Here, when the second image formed by only the first color component or the second color component of the plurality of color components is generated, the product-sum operation unit may use a virtual color difference of the prediction tap as a variable and operate a virtual color difference of the second image through a product-sum operation using the read coefficient, and the prediction tap formed by only a pixel corresponding to the first color component or the second color component may be acquired from the designated region of the first image.

In the image processing apparatus, the virtual color difference operation unit may be controlled to perform or stop an operation on the basis of the color variation amounts and the normalized dynamic ranges.

In the image processing apparatus, the virtual color difference operation unit may operate the virtual color difference by multiplying a value of the pixel forming the prediction tap by a matrix coefficient stipulated in a color space standard.

The image processing apparatus may further include another color component conversion unit that converts pixel values of each color component of a class tap into conversion values which are obtained by offsetting the pixel values with respect to a pixel value of one of the plurality of color components serving as a reference, the class tap including pixel values related to predetermined pixels of the designated region for the class tap. Here, the class sorting unit may determine a feature amount of the class tap on the basis of the conversion values obtained by another color component conversion unit.

In the image processing apparatus, the coefficient read by the coefficient reading unit may be obtained in advance through learning. In addition, in the learning, images, which are formed by image signals output from a plurality of pixel portions each of which includes pixels of only a single color component of the plurality of color components, may be used as teacher images, the pixel portions being disposed at a position closer to a subject than an optical low-pass filter disposed between the single-plate type pixel portion and the subject; an image formed by the image signals output from the single-plate type pixel portion may be used as a student image; and the coefficient may be calculated by solving a normal equation which maps the pixel of the student image and the pixel of the teacher image to each other.

According to another embodiment of the present technology, there is provided an image processing method including causing a color variation amount/normalized dynamic range operation unit to select a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component; causing a class sorting unit to perform class sorting on the designated region on the basis of a feature amount obtained from pixel values of the designated region; causing a coefficient reading unit to read a coefficient stored in advance on the basis of a result of the class sorting; and causing a product-sum operation unit to use a prediction tap including pixel values related to predetermined pixels of the designated region for the prediction tap as a variable, and operate pixel values of second images through a product-sum operation using the read coefficient, each of the second images being formed by pixels of only a single color component of the plurality of color components, in which an operation method of pixel values of the second image formed by pixels of only the first color component and an operation method of pixel values of the second image formed by pixels of only the second color component are changed on the basis of the color variation amounts and the normalized dynamic ranges.

According to still another embodiment of the present technology, there is provided a program causing a computer to function as an image processing apparatus including a color variation amount/normalized dynamic range operation unit that selects a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component; a class sorting unit that performs class sorting on the designated region on the basis of a feature amount obtained from pixel values of the designated region; a coefficient reading unit that reads a coefficient stored in advance on the basis of a result of the class sorting; and a product-sum operation unit that uses a prediction tap including pixel values related to predetermined pixels of the designated region for the prediction tap as a variable, and operates pixel values of second images through a product-sum operation using the read coefficient, each of the second images being formed by pixels of only a single color component of the plurality of color components, in which an operation method of pixel values of the second image formed by pixels of only the first color component and an operation method of pixel values of the second image formed by pixels of only the second color component are changed on the basis of the color variation amounts and the normalized dynamic ranges.

According to the embodiment of the present technology, a designated region which is a region including a predetermined number of pixels is selected from a first image formed by image signals which are output from a single-plate type pixel portion where pixels respectively corresponding to a plurality of color components are regularly disposed on a plane; color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component, are operated; class sorting is performed on the designated region on the basis of a feature amount obtained from pixel values of the designated region; a coefficient stored in advance is read on the basis of a result of the class sorting; and a prediction tap including pixel values related to predetermined pixels of the designated region for the prediction tap is used as a variable, and pixel values of second images are operated through a product-sum operation using the read coefficient, each of the second images being formed by pixels of only a single color component of the plurality of color components. In addition, an operation method of pixel values of the second image formed by pixels of only the first color component and an operation method of pixel values of the second image formed by pixels of only the second color component are changed on the basis of the color variation amounts and the normalized dynamic ranges.

According to the present technology, it is possible to obtain an image signal of each color component from an output of an image sensor having a color filter array formed by a plurality of color components without deterioration in image quality.

### BRIEF DESCRIPTION OF THE DRAWINGS

FIG. 1 is a diagram illustrating an image signal acquisition method in an image sensor of a single-plate type camera;

FIG. 2 is a block diagram illustrating a configuration example according to an embodiment of an image processing apparatus to which the present technology is applied;

FIG. 3 is a diagram illustrating an example of a designated region;

FIG. 4 is a diagram illustrating an example of a calculation method of an interpolation value g;

FIG. 5 is a diagram illustrating an example of a calculation method of an interpolation value r;

FIG. 6 is a diagram illustrating an example of a calculation method of an interpolation value b;

FIG. 7 is a diagram illustrating an example of a G class tap and a G prediction tap acquired in the image processing apparatus of FIG. 2;

FIGS. 8A to 8D are diagrams illustrating examples of an R class tap and an R prediction tap acquired in the image processing apparatus of FIG. 2;

FIGS. 9A to 9D are diagrams illustrating examples of a B class tap and a B prediction tap acquired in the image processing apparatus of FIG. 2;

FIG. 10 is a diagram illustrating a configuration example of a learning apparatus related to learning of a G coefficient, corresponding to the image processing apparatus of FIG. 2;

FIG. 11 is a diagram illustrating a configuration example of a learning apparatus related to learning of an R coefficient and a B coefficient, corresponding to the image processing apparatus of FIG. 2;

FIG. 12 is a flowchart illustrating an example of a G output image generation process performed by the image processing apparatus of FIG. 2;

FIG. 13 is a flowchart illustrating an example of a representative RGB operation process;

FIG. 14 is a flowchart illustrating an example of an RB output image generation process performed by the image processing apparatus of FIG. 2;

FIG. 15 is a flowchart illustrating an example of a color variation amount/normalized dynamic range operation process;

FIG. 16 is a flowchart illustrating an example of a G coefficient learning process performed by the learning apparatus of FIG. 10;

FIG. 17 is a flowchart illustrating an example of an RB coefficient learning process performed by the learning apparatus of FIG. 11;

FIG. 18 is a block diagram illustrating a configuration example according to another embodiment of an image processing apparatus to which the present technology is applied;

FIGS. 19A and 19B are diagrams illustrating examples of a structure of a class tap or a prediction tap which is acquired in the learning apparatus of FIG. 18;

FIGS. 20A and 20B are diagrams illustrating examples of a structure of a class tap or a prediction tap which is acquired in the learning apparatus of FIG. 18; and

FIG. 21 is a block diagram illustrating a configuration example of a personal computer.

### DETAILED DESCRIPTION OF EMBODIMENTS

Hereinafter, with reference to the drawings, embodiments of the present technology will be described.

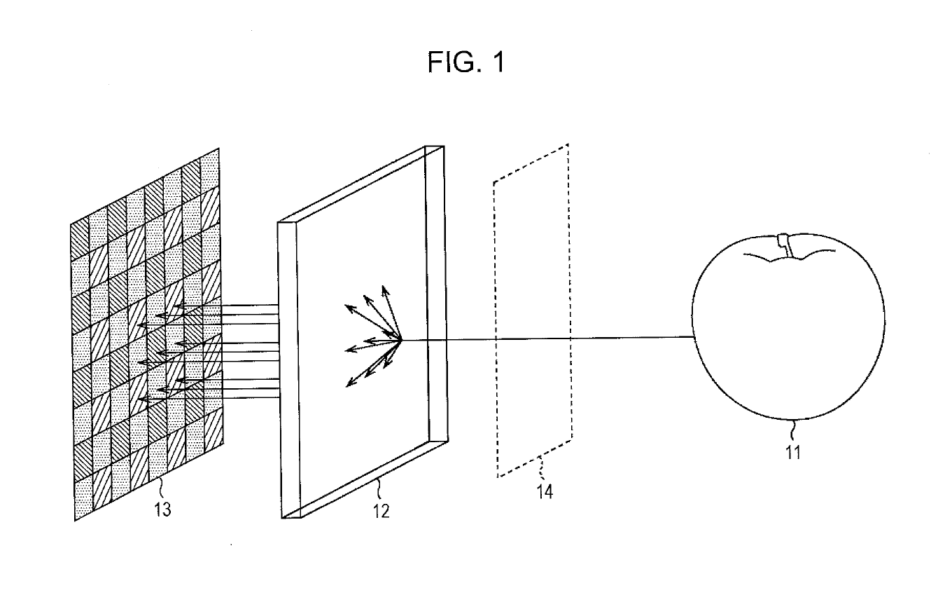

FIG. 1 is a diagram illustrating an image signal acquisition method in an image sensor of a single-plate type camera.

In this example, light reflected by a subject 11 passes through an optical low-pass filter 12 and is received by an image sensor 13.

In the single-plate type camera, a single image sensor is used in which a color coding filter formed by an array of a color filter assigned to each pixel is provided on a front surface, and a color component signal which is color-coded by the color coding filter is obtained for each pixel.

Here, a color filter array with the Bayer array is used in the image sensor 13, and G filters are disposed in a checkered pattern, and R and B filters are alternately disposed for each column in the remaining parts. In other words, four pixels in the rectangular region in the image sensor 13 include two G pixels, a single R pixel, and a single B pixel.

In the single-plate type camera, when the signal of each pixel is processed in a subsequent stage of an image process, R component, G component, and B component image signals are necessary every pixel. For this reason, it is necessary to obtain R component, G component, and B component pixel values every pixel through an interpolation operation or the like, on the basis of pixel values output from the image sensor 13.

In addition, in the image sensor 13, the light incident to the image sensor is made to pass through the optical low-pass filter 12 in order to prevent an influence of false color, artifact, or the like. However, if the light is made to pass through the optical low-pass filter 12 as above, an image may be blurred.

Therefore, in the present technology, on the basis of pixel values output from the image sensor 13, pixel values can be obtained which are obtained assuming that three image sensors respectively corresponding to an R component, a G component, and a B component are disposed in a frame (the dotted rectangle in FIG. 1) 14.

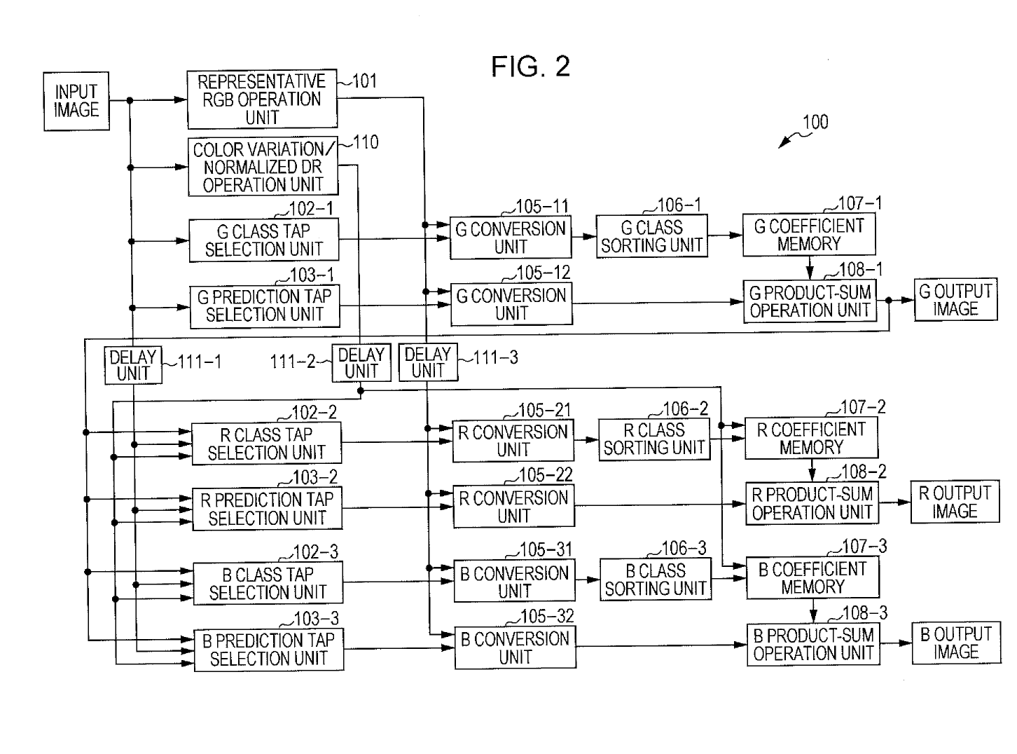

FIG. 2 is a block diagram illustrating a configuration example according to an embodiment of an image processing apparatus to which the present technology is applied. An image processing apparatus 100 uses values of a pixel corresponding to a target pixel and peripheral pixels thereof as variables in an input image, and predicts a pixel value of the target pixel of an output image through a product-sum operation using a coefficient which is obtained in advance through learning.

The input image which is input to the image processing apparatus 100 is an image formed using output values of an image sensor which uses, for example, a color filter array with the Bayer array. In other words, the input image is an image corresponding to signals output from, for example, the image sensor 13 of FIG. 1. Therefore, in the input image, an R component image signal is obtained from a pixel in which an R filter is disposed, but G component and B component image signals are not be obtained therefrom. Similarly, only a G component image signal is obtained from a G pixel, and R component and B component image signals are not obtained therefrom. Only a B component image signal is obtained from a B pixel, and R component and G component image signals are not obtained therefrom.

The image processing apparatus 100 of FIG. 2 includes a representative RGB operation unit 101, a color variation/normalized DR operation unit 110, and class tap selection units respectively corresponding to R, G and B, prediction tap selection units respectively corresponding to R, G and B, color conversion units respectively corresponding to R, G and B, class sorting units respectively corresponding to R, G and B, coefficient memories respectively corresponding to R, G and B, and product-sum operation units respectively corresponding to R, G and B.

The representative RGB operation unit 101 operates Dr, Db, and Dg, as representative values serving as a reference of a pixel value of each color component of R, G and B in a region (hereinafter, referred to as a designated region) in an image, for acquiring a class tap or a prediction tap described later.

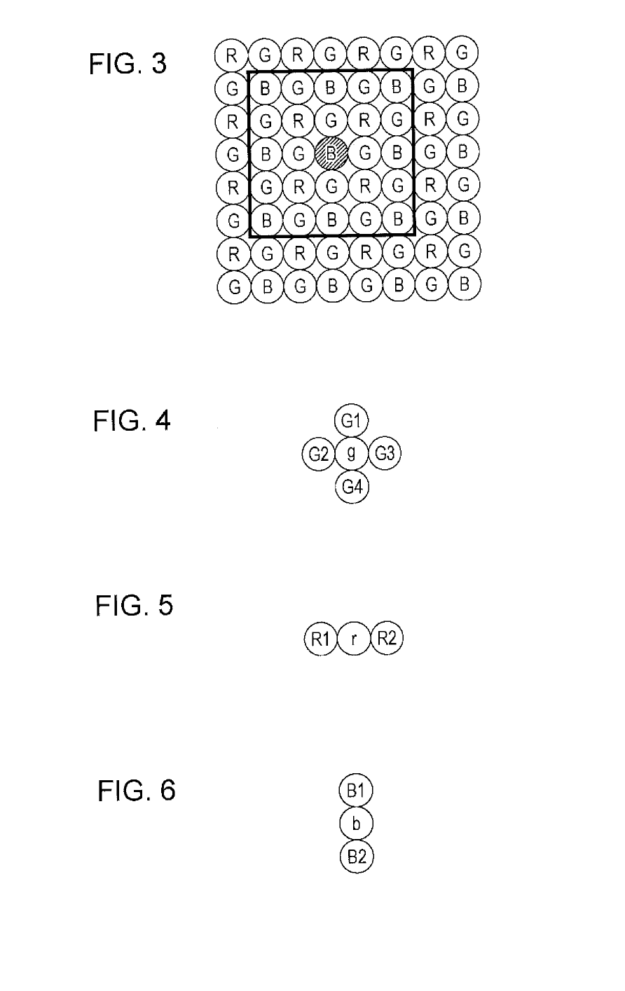

For example, it is assumed that the designated region is set as illustrated in a solid frame of FIG. 3. In FIG. 3, each of the circles indicates a pixel of the input image, and a pixel indicated by the hatched circle in the center is regarded a central pixel of a class tap or a prediction tap. In addition, the letters R, G and B recorded in the respective circles indicates color components of respective pixels.

The designated region is arbitrarily set to a region including a class tap or a prediction tap centering on the central pixel, but if a region which considerably exceeds a class tap or a prediction tap is set, it may be difficult to perform an optimal process corresponding to an image region. For this reason, the designated region is preferably the same region as a class tap or a prediction tap.

In addition, in the following description, an average value, an interpolation value, a representative value, and the like calculated through operations are appropriately referred to, but respective pixel values of an input image before the operations are performed are referred to as an input value G, an input value R, and an input value B for differentiation from each other, in accordance with color components of the respective pixels. In other words, a pixel value which is directly obtained from a pixel where an R filter of an image sensor with the Bayer array is set to an input value R; a pixel value which is directly obtained from a pixel where a G filter of the image sensor with the Bayer array is set to an input value G; and a pixel value which is directly obtained from a pixel where a B filter of the image sensor with the Bayer array is set to an input value B.

In this example, a region which is surrounded by the solid line in FIG. 3 and includes 25(=5×5) pixels centering on the central pixel is set as the designated region.

The representative RGB operation unit 101 first calculates a G component representative value Dg.

At this time, the representative RGB operation unit 101, as illustrated in FIG. 4, uses the R component pixel or the B component pixel in the designated region as a central pixel, and averages an input value G1 to an input value G4 of the pixel G1 to the pixel G4 which are four peripheral pixels (top and bottom and right and left) of the central pixel, thereby calculating an interpolation value g which is a value of the G component interpolated at the pixel position of the central pixel. Accordingly, the R component pixel and the B component pixel which do not have the G component in the input image have the interpolated G component (interpolation value g).

In addition, the representative RGB operation unit 101 calculates an average value of input values G of all the G pixels (twelve in this example) and the interpolation value g as a representative value Dg.

Next, the representative RGB operation unit 101 calculates an R component representative value Dr. At this time, the representative RGB operation unit 101 calculates an interpolation value r which is a value of the R component interpolated at each pixel position of the G pixels in the designated region. For example, in a case of calculating the interpolation value r at the position of the pixel G1 or the pixel G4 of FIG. 4, as illustrated in FIG. 5, an average value of the pixel R2 and the pixel R1 which are adjacent to the G pixel on both of right and left sides is regarded as the interpolation value r.

Accordingly, the input value G and the interpolation value r can be obtained at the pixel position of the G pixel in the designated region, and an input value R and an interpolation value g can be obtained at the pixel position of the R pixel in the designated region.

In addition, (interpolation value r−input value G) and (input value R−interpolation value g) are calculated at each pixel position, and a value obtained by adding the representative value Dg to an average value of the calculated (interpolation value r−input value G) and (input value R−interpolation value g) is calculated as a representative value Dr.

Next, the representative RGB operation unit 101 calculates a B component representative value Db. At this time, the representative RGB operation unit 101 calculates an interpolation value b which is a value of the B component interpolated at each pixel position of the G pixels in the designated region. For example, in a case of calculating the interpolation value b at the position of the pixel G1 or the pixel G4 of FIG. 4, as illustrated in FIG. 6, an average value of the pixel B1 and the pixel B2 which are adjacent to the G pixel on both of top and bottom sides is regarded as the interpolation value b.

Accordingly, the input value G and the interpolation value b can be obtained at the pixel position of the G pixel in the designated region, and an input value B and an interpolation value g can be obtained at the pixel position of the B pixel in the designated region.

In addition, (interpolation value b−input value G) and (input value B−interpolation value g) are calculated at each pixel position, and a value obtained by adding the representative value Dg to an average value of the calculated (interpolation value b−input value G) and (input value B−interpolation value g) is calculated as a representative value Db.

Referring to FIG. 2 again, the color variation/normalized DR operation unit 110 calculates color variation amounts including a variation amount of an R component pixel value for a G component pixel value and a variation amount of a B component pixel value for the G component pixel value of the image sensor with the Bayer array. In addition, the color variation/normalized DR operation unit 110 calculates normalized dynamic ranges including a value obtained by normalizing a dynamic range of the R component pixel value of the image sensor with the Bayer array, a value obtained by normalizing a dynamic range of the G component pixel value thereof, and a value obtained by normalizing a dynamic range of the B component pixel value thereof.

The color variation/normalized DR operation unit 110 calculates a color variation amount Rv related to the R component pixel. At this time, a value, which is obtained by multiplying a dynamic range of a difference value between the input value R of the R component pixel of the designated region and the interpolation value g by 256/Dg, is calculated as the color variation amount Rv. In other words, the color variation amount Rv is calculated as a value indicating a color variation amount of the R component for the 0 component in the pixels of the designated region.

In addition, the color variation/normalized DR operation unit 110 calculates a color variation amount Bv related to the B component pixel. At this time, a value, which is obtained by multiplying a dynamic range of a difference value between the input value B of the B component pixel of the designated region and the interpolation value g by 256/Dg, is calculated as the color variation amount Bv. In other words, the color variation amount Bv is calculated as a value indicating a color variation amount of the R component for the G component in the pixels of the designated region.

The color variation/normalized DR operation unit 110 calculates a normalized dynamic range NDR_R related to the R component pixel. At this time, a value, which is obtained by dividing a dynamic range DR_R of the input value R in the designated region by an average value of the input value R in the designated region, is calculated as the normalized dynamic range NDR_R.

In addition, the color variation/normalized DR operation unit 110 calculates a normalized dynamic range NDR_G related to the G component pixel. At this time, a value, which is obtained by dividing a dynamic range DR_G of the input value G in the designated region by an average value of the input value G in the designated region, is calculated as the normalized dynamic range NDR_G.

Further, the color variation/normalized DR operation unit 110 calculates a normalized dynamic range NDR_B related to the B component pixel. At this time, a value, which is obtained by dividing a dynamic range DR_B of the input value B in the designated region by an average value of the input value B in the designated region, is calculated as the normalized dynamic range NDR_B.

The G class tap selection unit 102-1 selects and acquires a G class tap which is necessary in generating a G component image, from the input image. The G class tap is formed by, for example, a predetermined number of pixels centering on a central pixel, and the central pixel is a pixel of the input image at a position corresponding to a target pixel of an output image. In addition, details of the G class tap will be described later.

The G class tap selected by the G class tap selection unit 102-1 is supplied to the G conversion unit 105-11. The G conversion unit 105-11 performs a G conversion process on each pixel value forming the G class tap.

The G conversion process is performed as follows, for example. In a case where a pixel value forming the G class tap is the input value G, a conversion value G′ is operated; in a case where a pixel value forming the G class tap is the input value R, a conversion value R′ is operated; and in a case where a pixel value forming the G class tap is the input value B, a conversion value B′ is operated.

Here, the conversion value G′, the conversion value R′, and the conversion value B′ are respectively operated using Equations (1) to (3)

G′=G (1)

R′=R−(Dr−Dg) (2)

B′=B−(Db−Dg) (3)

It is possible to increase the correlation of each pixel value forming the G class tap by performing the G conversion process. In other words, each pixel value of the R pixel and the B pixel of the input image is offset with respect to the pixel value of the G pixel as a reference, and thus it is possible to remove a variation due to a color component difference of each pixel value forming the G class tap.

Referring to FIG. 2 again, the G class tap output from the G conversion unit 105-11 is supplied to the G class sorting unit 106-1. In addition, the G class tap output from the G conversion unit 105-11 includes the conversion value G′, the conversion value R′, and the conversion value B′ which have been operated using the above Equations (1) to (3).

The G class sorting unit 106-1 codes the supplied G class tap by using adaptive dynamic range coding (ADRC) so as to generate a class code. The class code generated here is output to the G coefficient memory 107-1.

The G coefficient memory 107-1 reads a coefficient which is stored in correlation with the class code output from the G class sorting unit 106-1, and supplies the read coefficient to the G product-sum operation unit 108-1. In addition, the C coefficient memory 107-1 stores a coefficient which is obtained in advance through learning and is used in a product-sum operation described later, in correlation with the class code.

The G prediction tap selection unit 103-1 selects and acquires a G prediction tap which is a prediction tap necessary in generating a G component image from the input image. The G prediction tap is formed by, for example, a predetermined number of pixels centering on a central pixel, and the central pixel is a pixel of the input image at a position corresponding to a target pixel of an output image. In addition, details of the G prediction tap will be described later.

The G prediction tap selected by the G prediction tap selection unit 103-1 is supplied to the G conversion unit 105-12. The G conversion unit 105-12 performs a G conversion process on each pixel value forming the G prediction tap.

The G conversion process performed by the G conversion unit 105-12 is the same as the one performed by the G conversion unit 105-11. In other words, by using the above Equations (1) to (3), in a case where a pixel value forming the G prediction tap is the input value G, a conversion value G′ is operated; in a case where a pixel value forming the G prediction tap is the input value R, a conversion value R′ is operated; and in a case where a pixel value forming the G prediction tap is the input value B, a conversion value B′ is operated.

The G prediction tap output from the G conversion unit 105-12 is supplied to the G product-sum operation unit 108-1. In addition, the G prediction tap output from the G conversion unit 105-12 includes the conversion value G′, the conversion value R′, and the conversion value B′ which have been operated using the above Equations (1) to (3).

The G product-sum operation unit 108-1 assigns the G prediction tap which is output from the G conversion unit 105-12, to a linear first order equation set in advance, as a variable, and performs an operation of a prediction value by using the coefficient supplied from the G coefficient memory 107-1. In other words, the G product-sum operation unit 108-1 predictively operates a pixel value of a target pixel in a G component image (hereinafter, referred to as a G output image) which is an output image, on the basis of the G prediction tap.

Here, a description will be made of a predictive operation of the pixel value of the target pixel of the output image.

For example, it is assumed that image data output from the image sensor having the color filter array with the Bayer array is first image data, and image data output from the G component image sensor disposed in the frame 14 of FIG. 1 is second image data. In addition, it is considered that a pixel value of the second image data is obtained from a pixel value of the first image data through a predetermined predictive operation.

When, for example, a linear first order predictive operation is employed as the predetermined predictive operation, a pixel value y of a pixel of the second image data (hereinafter, appropriately referred to as a pixel of the second image) is obtained using the following linear first order equation.

$$y = {\sum }_{n = 1}^{N} {w}_{n} {x}_{n} \qquad ( 4 )$$

Here, in Equation (4), xₙ indicates a pixel value of an n-th pixel of the first image data (hereinafter, appropriately referred to as a pixel of the first image), forming the prediction tap for a pixel y of the second image, and wₙ indicates an n-th tap coefficient multiplied by the n-th pixel (a pixel value thereof) of the first image. In addition, in Equation (4), the prediction tap is formed by N pixels x₁, x₂, . . . , and x_{N} of the first image.

Here, the pixel value y of the pixel of the second image may be obtained using second or higher order equations, instead of the linear first order equation represented by Equation (4).

Here, when a true value of a pixel value of a pixel of the second image of a k-th sample is denoted by yₖ, and a prediction value of the true value yₖ obtained using Equation (4) is denoted by yₖ′, a prediction error eₖ thereof is expressed by the following Equation.

eₖ=yₖ−yₖ′ (5)

The prediction value yₖ′ of Equation (5) is obtained according to Equation (4), and thus yₖ′ of Equation (5) is replaced according to Equation (4), which leads to the following Equation.

$${e}_{k} = {y}_{k} - ( {\sum }_{n = 1}^{N} {w}_{n} {x}_{n , k} ) \qquad ( 6 )$$

Here, in Equation (6), x_{n,k} indicates the n-th pixel of the first image forming the prediction tap for a pixel of the second image of the k-th sample.

A tap coefficient wₙ which produces the prediction error eₖ of Equation (6) (or Equation (5)) as 0 is the optimum in predicting a pixel of the second image, but it may be generally difficult to obtain such a tap coefficient wₙ for all pixels of the second image.

Therefore, if, for example, a least-square method is employed as a model indicating that the tap coefficient wₙ is the optimum, an optimal tap coefficient wₙ may be obtained by making a sum total E of square errors expressed by the following Equation minimum.

$$E = {\sum }_{k = 1}^{K} {e}_{k}^{2} . \qquad ( 7 )$$

Here, in Equation (7), K indicates the number of samples (the number of samples for learning) of sets of a pixel yₖ of the second image and pixels x_{1,k}, x_{2,k}, . . . , and x_{N,k} of the first image forming a prediction tap for the pixel yₖ of the second image.

A minimum value of the sum total E of square errors of Equation (7) is given by wₙ which produces, as 0, a result of partial differentiation of the sum total E using the tap coefficient wₙ, as represented in Equation (8).

$$\frac{\partial E}{\partial {w}_{n}} = {e}_{1} \frac{\partial {e}_{1}}{\partial {w}_{n}} + {e}_{2} \frac{\partial {e}_{2}}{\partial {w}_{n}} + … + {e}_{k} \frac{\partial {e}_{k}}{\partial {w}_{n}} = 0 \\ ( n = 1 , 2 , … , N ) \qquad ( 8 )$$

Therefore, when partial differentiation is applied to the above Equation (6) by using the tap coefficient wₙ, the following Equation may be obtained.

$$\frac{\partial {e}_{k}}{\partial {w}_{1}} = - {x}_{1 , k} , \frac{\partial {e}_{k}}{\partial {w}_{2}} = - {x}_{2 , k} , … , \frac{\partial {e}_{k}}{\partial {w}_{N}} = - {x}_{N , k} , \\ ( k = 1 , 2 , … , K ) \qquad ( 9 )$$

The following Equation may be obtained from Equations (8) and (9).

$${\sum }_{k = 1}^{K} {e}_{k} {x}_{1 , k} = 0 , {\sum }_{k = 1}^{K} {e}_{k} {x}_{2 , k} = 0 , … {\sum }_{k = 1}^{K} {e}_{k} {x}_{N , k} = 0 \qquad ( 10 )$$

Equation (6) is assigned to eₖ of Equation (10), and thus Equation (10) may be expressed by a normal equation represented in Equation (11).

$$[ \begin{matrix}( {\sum }_{k = 1}^{K} {x}_{1 , k} {x}_{1 , k} ) & ( {\sum }_{k = 1}^{K} {x}_{1 , k} {x}_{2 , k} ) & … & ( {\sum }_{k = 1}^{K} {x}_{1 , k} {x}_{N , k} ) \\ ( {\sum }_{k = 1}^{K} {x}_{2 , k} {x}_{1 , k} ) & ( {\sum }_{k = 1}^{K} {x}_{2 , k} {x}_{2 , k} ) & … & ( {\sum }_{k = 1}^{K} {x}_{2 , k} {x}_{N , k} ) \\ ⋮ & ⋮ & ⋱ & ⋮ \\ ( {\sum }_{k = 1}^{K} {x}_{N , k} {x}_{1 , k} ) & ( {\sum }_{k = 1}^{K} {x}_{N , k} {x}_{2 , k} ) & … & ( {\sum }_{k = 1}^{K} {x}_{N , k} {x}_{N , k} )\end{matrix} ] [ \begin{matrix}{w}_{1} \\ {w}_{2} \\ ⋮ \\ {w}_{N}\end{matrix} ] = [ \begin{matrix}( {\sum }_{k = 1}^{K} {x}_{1 , k} {y}_{k} ) \\ ( {\sum }_{k = 1}^{K} {x}_{2 , k} {y}_{k} ) \\ ⋮ \\ ( {\sum }_{k = 1}^{K} {x}_{N , k} {y}_{k} )\end{matrix} ] \qquad ( 11 )$$

The normal equation of Equation (11) can be solved with respect to the tap coefficient wₙ by using, for example, a sweep-out method (Gauss-Jordan elimination).

The normal equation of Equation (11) is taken and solved for each class, and thus an optimal tap coefficient (here, a tap coefficient which makes the sum total E of square errors minimum) wₙ can be obtained for each class. For example, the tap coefficient wₙ obtained in this way is stored in the G coefficient memory 107-1 as a G coefficient. In addition, a method of preliminarily obtaining the coefficient through learning will be described later in detail.

For example, the G prediction tap on which the process in the G conversion unit 105-12 has been performed is assigned to the pixels x₁, x₂, . . . , and x_{N} of Equation (4), the tap coefficient wₙ of Equation (4) is supplied from the G coefficient memory 107-1, and then the operation of Equation (4) is performed by the G product-sum operation unit 108-1, thereby predicting a pixel value of a target pixel of the output image.

In this way, each target pixel is predicted, and thus the G output image can be obtained.

The data output from the G product-sum operation unit 108-1 is supplied to the R class tap selection unit 102-2 and the R prediction tap selection unit 103-2, and the B class tap selection unit 102-3 and the B prediction tap selection unit 103-3. In addition, the input image is supplied to the R class tap selection unit 102-2 and the R prediction tap selection unit 103-2, and the B class tap selection unit 102-3 and the B prediction tap selection unit 103-3, via a delay unit 111-1.

Further, the data output from the color variation/normalized DR operation unit 110 is supplied to the R class tap selection unit 102-2 and the R prediction tap selection unit 103-2, and the B class tap selection unit 102-3 and the B prediction tap selection unit 103-3, via a delay unit 111-2. Furthermore, the data output from the color variation/normalized DR operation unit 110 is supplied to the R coefficient memory 107-2 and the R product-sum operation unit 108-2, and the B coefficient memory 107-3 and the B product-sum operation unit 108-3, via the delay unit 111-2.

In addition, the data output from the representative RGB operation unit 101 is supplied to the R conversion unit 105-21 and the R conversion unit 105-22, and the B conversion unit 105-31 and the B conversion unit 105-32 via a delay unit 111-3.

The R class tap selection unit 102-2 selects and acquires an R class tap which is necessary in generating an R component image, from the input image or the G output image. The R class tap is formed by, for example, a predetermined number of pixels centering on a central pixel, and the central pixel is a pixel of the G output image at a position corresponding to a target pixel of an output image.

In addition, the R class tap selection unit 102-2 changes a structure of the acquired R class tap on the basis of an output value from the color variation/normalized DR operation unit 110. Details of the R class tap will be described later.

The R class tap selected by the R class tap selection unit 102-2 is supplied to the R conversion unit 105-21. The R conversion unit 105-21 performs an R conversion process on each pixel value forming the R class tap.

The R conversion process here is performed as follows, for example.

Here, a G component pixel of the G output image is indicated by a prediction value Gp.

The R conversion unit 105-21 performs an operation of Equation (12) on the pixel value of the C output image, forming the R class tap, so as to calculate a conversion value Gp′.

Gp′=Gp−(Dg−Dr) (12)

It is possible to increase the correlation of each pixel value forming the R class tap by performing the R conversion process. In other words, the pixel value of the G output image is offset with respect to the pixel value of the R pixel of the input image as a reference, and thus it is possible to remove a variation due to a color component difference of each pixel value forming the R class tap.

The R class tap output from the R conversion unit 105-21 is supplied to the R class sorting unit 106-2.

The R class sorting unit 106-2 codes the supplied R class tap by using adaptive dynamic range coding (ADRC) so as to generate a class code. The class code generated here is output to the R coefficient memory 107-2.

The R coefficient memory 107-2 reads a stored coefficient, and supplies the read coefficient to the R product-sum operation unit 108-2. In addition, the R coefficient memory 107-2 stores a coefficient which is obtained in advance through learning and is used in a product-sum operation, in correlation with the class code and a tap mode described later.

The R prediction tap selection unit 103-2 selects and acquires an R prediction tap which is a prediction tap necessary in generating the R component image from the G output image. The R prediction tap is formed by, for example, a predetermined number of pixels centering on a central pixel, and the central pixel is a pixel of the G output image at a position corresponding to a target pixel of an output image. The R prediction tap is selected from the G output image, and, thus, in this case, the R prediction tap is formed by only the G component pixel.

The R prediction tap selection unit 103-2 changes a structure of the acquired R prediction tap on the basis of an output value from the color variation/normalized DR operation unit 110. In addition, details of the R prediction tap will be described later.

The R prediction tap selected by the R prediction tap selection unit 103-2 is supplied to the R conversion unit 105-22. The R conversion unit 105-22 performs an R conversion process on each pixel value forming the R prediction tap.

An R conversion process performed by the R conversion unit 105-22 is the same as the one performed by the R conversion unit 105-21. In other words, the conversion value Gp′ is operated using the above Equation (12).

It is possible to increase the correlation of each pixel value forming the R prediction tap by performing the R conversion process. In other words, the pixel value of the G output image is offset with respect to the pixel value of the R pixel of the input image as a reference, and thus it is possible to remove a variation due to a color component difference of each pixel value forming the R prediction tap.

The R prediction tap output from the R conversion unit 105-22 is supplied to the R product-sum operation unit 108-2. In addition, the R prediction tap output from the R conversion unit 105-22 includes the conversion value Gp′ which has been operated using the above Equation (12).

The R product-sum operation unit 108-2 assigns the R prediction tap which is output from the G conversion unit 105-22, to a linear first order equation set in advance, as a variable, and performs an operation of a prediction value by using the coefficient supplied from the R coefficient memory 107-2. In other words, the R product-sum operation unit 108-2 predictively operates a pixel value of a target pixel in an R component image (hereinafter, referred to as an R output image) which is an output image, on the basis of the R prediction tap.

For example, the R prediction tap on which the process in the R conversion unit 105-22 has been performed is assigned to the pixels x₁, x₂, . . . , and x_{N} of Equation (4), the tap coefficient wₙ of Equation (4) is supplied from the R coefficient memory 107-2, and then the operation of Equation (4) is performed by the R product-sum operation unit 108-2, thereby predicting a pixel value of a target pixel of the output image.

In addition, since a structure of the R prediction tap is changed on the basis of an output value from the color variation/normalized DR operation unit 110, the number of variables of the linear first order equation is changed on the basis of an output value from the R product-sum operation unit 108-2 or the color variation/normalized DR operation unit 110.

In this way, each target pixel is predicted, and thus the R output image can be obtained.

The B class tap selection unit 102-3 selects and acquires a B class tap which is necessary in generating a B component image, from the input image or the G output image. The B class tap is formed by, for example, a predetermined number of pixels centering on a central pixel, and the central pixel is a pixel of the G output image at a position corresponding to a target pixel of an output image.

In addition, the B class tap selection unit 102-3 changes a structure of the acquired B class tap on the basis of an output value from the color variation/normalized DR operation unit 110. Details of the B class tap will be described later.

The B class tap selected by the B class tap selection unit 102-3 is supplied to the B conversion unit 105-31. The B conversion unit 105-31 performs a B conversion process on each pixel value forming the B class tap.

The B conversion process is performed as follows, for example.

Here, a G component pixel of the G output image is indicated by a prediction value Gp.

The B conversion unit 105-31 performs an operation of Equation (13) on the pixel value of the G output image, forming the B class tap, so as to calculate a conversion value Gp′.

Gp′=Gp−(Dg−Db). (13)

It is possible to increase the correlation of each pixel value forming the B class tap by performing the B conversion process. In other words, the pixel value of the G output image is offset with respect to the pixel value of the B pixel of the input image, serving as a reference, and thus it is possible to remove a variation due to a color component difference of each pixel value forming the B class tap.

The B class tap output from the B conversion unit 105-31 is supplied to the B class sorting unit 106-3.

The B class sorting unit 106-3 codes the supplied B class tap by using adaptive dynamic range coding (ADRC) so as to generate a class code. The class code generated here is output to the B coefficient memory 107-3.

The B coefficient memory 107-3 reads a stored coefficient, and supplies the read coefficient to the B product-sum operation unit 108-3. In addition, the B coefficient memory 107-3 stores a coefficient which is obtained in advance through learning and is used in a product-sum operation described later, in correlation with the class code.

The B prediction tap selection unit 103-3 selects and acquires a B prediction tap which is a prediction tap necessary in generating the B component image from the G output image. The B prediction tap is formed by, for example, a predetermined number of pixels centering on a central pixel, and the central pixel is a pixel of the G output image at a position corresponding to a target pixel of an output image.

The B prediction tap selection unit 103-3 changes a structure of the acquired B prediction tap on the basis of an output value from the color variation/normalized DR operation unit 110. In addition, details of the B prediction tap will be described later.

The B prediction tap selected by the B prediction tap selection unit 103-3 is supplied to the B conversion unit 105-32. The B conversion unit 105-32 performs a B conversion process on each pixel value of the G output image forming the B prediction tap.

The B conversion process performed by the B conversion unit 105-32 is the same as the one performed by the B conversion unit 105-31. In other words, the conversion value Gp′ is operated using the above Equation (13).

It is possible to increase the correlation of each pixel value forming the B prediction tap by performing the B conversion process. In other words, the pixel value of the G output image is offset with respect to a pixel value of the B pixel of the input image, serving as a reference, and thus it is possible to remove a variation due to a color component difference of each pixel value forming the B prediction tap.

The B prediction tap output from the B conversion unit 105-32 is supplied to the B product-sum operation unit 108-3.

The B product-sum operation unit 108-3 assigns the B prediction tap which is output from the G conversion unit 105-32, to a linear first order equation set in advance, as a variable, and performs an operation of a prediction value by using the coefficient supplied from the B coefficient memory 107-3. In other words, the B product-sum operation unit 108-3 predictively operates a pixel value of a target pixel in a B component image (hereinafter, referred to as a B output image) which is an output image, on the basis of the G prediction tap.

For example, the B prediction tap on which the process in the B conversion unit 105-32 has been performed is assigned to the pixels x₁, x₂, . . . , and x_{N} of Equation (4), the tap coefficient wₙ of Equation (4) is supplied from the B coefficient memory 107-3, and then the operation of Equation (4) is performed by the B product-sum operation unit 108-3, thereby predicting a pixel value of a target pixel of the output image.

In addition, since a structure of the B prediction tap is changed on the basis of an output value from the color variation/normalized DR operation unit 110, the number of variables of the linear first order equation is changed on the basis of an output value from the B product-sum operation unit 108-3 or the color variation/normalized DR operation unit 110.

In this way, each target pixel is predicted, and thus the B output image can be obtained.

Next, each class tap and each prediction tap will be described in detail.

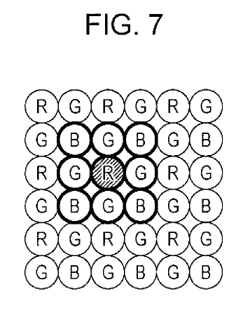

FIG. 7 is a diagram illustrating an example of the G class tap and the G prediction tap. Here, a pixel (R component pixel) which has R in the hatched circle in FIG. 7 is set as a central pixel. In addition, pixels indicated by the solid circles in FIG. 7 are pixels forming the G class tap or the G prediction tap.

In the example of FIG. 7, nine (=3×3) pixels centering on the central pixel form the G class tap and the G prediction tap. In addition, here, the G class tap and the G prediction tap are described as having the same structure, but the G class tap and the G prediction tap may have different structures.

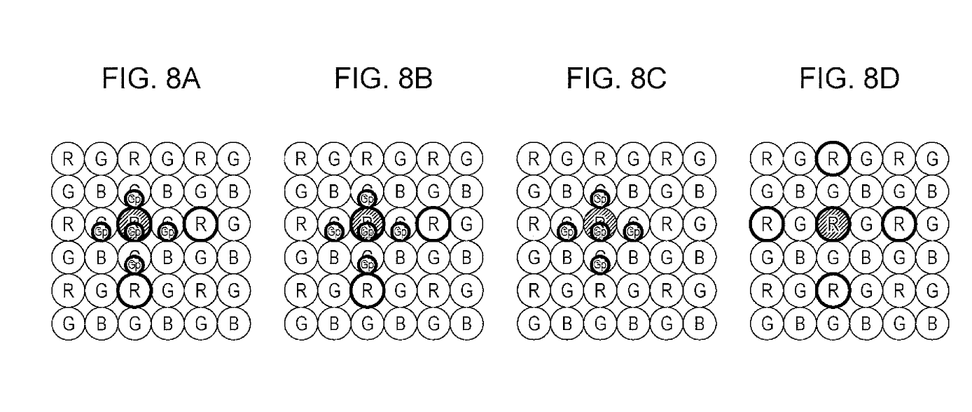

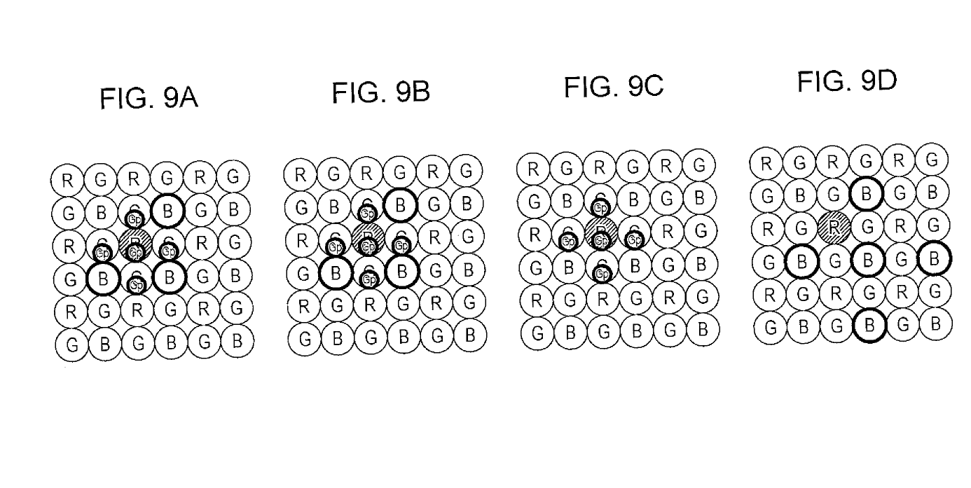

FIGS. 8A to 8D and FIGS. 9A to 9D are diagrams illustrating examples of the R class tap and the R prediction tap and the B class tap and the B prediction tap, respectively. In the same manner as in FIG. 7, a pixel (R component pixel) which has R in the hatched circle in FIGS. 8A to 9D is set as a central pixel. In addition, pixels indicated by the solid circles in FIGS. 8A to 9D are pixels forming each class tap or each prediction tap.

As described above, the R class tap selection unit 102-2 and the B class tap selection unit 102-3 respectively change structures of the acquired R class tap and B class tap on the basis of output values from the color variation/normalized DR operation unit 110. In addition, the R prediction tap selection unit 103-2 and the B prediction tap selection unit 103-3 respectively change structures of the acquired R prediction tap and B prediction tap on the basis of output values from the color variation/normalized DR operation unit 110.

The R class tap selection unit 102-2 and the B class tap selection unit 102-3, and the R prediction tap selection unit 103-2 and the B prediction tap selection unit 103-3 select tap modes so as to determine structures of each class tap and each prediction tap which are obtained. Here, a description will be made of an example in which a tap mode is selected from four modes including a tap mode 0 to a tap mode 3.

In a case where a tap mode of the R class tap or the R prediction tap is selected, a threshold value Ath and a threshold value Eth used in comparison of the normalized dynamic range NDR_R are set in advance. In addition, a threshold value Bth used in comparison of the color variation amount Rv is set in advance. Further, a threshold value Cth used in comparison of the normalized dynamic range NDR_G is set in advance. Furthermore, a threshold value Dth used in comparison of a difference absolute value of the color variation amount Rv and the color variation amount Bv is set in advance.

If NDR_G>threshold value C, and Rv≧Bth, the tap mode 1 is selected. The tap mode 1 is a tap mode selected when a pixel value variation between the G component pixels in the designated region is great, and a color variation amount of the R component pixel is large.

If |Rv−Bv|≦Dth, and NDR_R≦Eth, the tap mode 2 is selected. The tap mode 2 is a tap mode selected when a color variation amount between the R component pixel and the B component pixel is small, and a difference between pixel values of the R component pixels is also small.

If NDR_R≧Ath, and Rv≧Bth, the tap mode 3 is selected. The tap mode 3 is a tap mode selected when a variation amount of a pixel value of only the R component is large and variation amounts of pixel values of the other color components are small in the designated region.

In a case which does not correspond to any of the above cases, the tap mode 0 is selected.

FIG. 8A is a diagram illustrating an example of the R class tap or the R prediction tap when the tap mode 0 is selected. In the example of FIG. 8A, along with the central pixel, an R component pixel closest to the central pixel on the horizontally right side and an R component pixel closest to the central pixel on the vertically lower side are acquired as taps. In addition, prediction values Gp at respective positions of cross-shaped five pixels on top and bottom and right and left sides including the central pixel are acquired as taps. In other words, in a case of the tap mode 0, three taps (pixels) of the input value R, and five taps (pixels) of the prediction values Gp are acquired.

In addition, the R component pixel is used as a central pixel here, but if the G component or B component pixel is used as a central pixel, a position of a pixel serving as a reference is shifted to a position of the R component pixel close to the central pixel in relation to taps of the input value R. On the other hand, in relation of taps of the prediction value Gp, the taps are acquired in a cross shape centering on the G component or B component pixel.

FIG. 8B is a diagram illustrating an example of the R class tap or the R prediction tap when the tap mode 1 is selected. In this example, in a case of the tap mode 0 and in a case of the tap mode 1, the R class tap or the R prediction tap is similarly acquired.

In addition, in the tap mode 0 and the tap mode 1, a structure of the R class tap or the R prediction tap is not changed, but a coefficient read from the R coefficient memory 107-2 is different.

FIG. 8C is a diagram illustrating an example of the R class tap or the R prediction tap when the tap mode 2 is selected. In addition, in the example of FIG. 8C, a prediction value Gp in each of cross-shaped five pixels on top and bottom and right and left sides including the central pixel is acquired as taps.

As described above, the tap mode 2 is a tap mode selected when a color variation amount between the R component pixel and the B component pixel is small, and a difference between pixel values of the R component pixels is also small. If a pixel of an output image is generated (predicted) on the basis of the pixel of the designated region, a false color tends to occur in the output image. For this reason, in the present technology, in a case where the tap mode 2 is selected, a pixel of the input value R is not used to generate a pixel of an R output image.

FIG. 8D is a diagram illustrating an example of the R class tap or the R prediction tap when the tap mode 3 is selected. In the example of FIG. 8D, R component pixels closest to the central pixel on the horizontally left and right sides and R component pixels closest to the central pixel on the vertically upper and lower sides are acquired as taps.

In addition, the R component pixel is used as a central pixel here, but if the G component or B component pixel is used as a central pixel, a position of a pixel serving as a reference is shifted to a position of the R component pixel close to the central pixel in relation to taps of the input value R.

As described above, the tap mode 3 is a tap mode selected when a variation amount of a pixel value of only the R component is large and variation amounts of pixel values of the other color components are small in the designated region. If a pixel of an output image is generated (predicted) on the basis of the pixel of the designated region in the G output image, color bleeding or ringing tends to occur in the output image. For this reason, in the present technology, in a case where the tap mode 3 is selected, only a pixel of the input value R is used to generate a pixel of an R output image.

In a case where a tap mode of the B class tap or the B prediction tap is selected, a threshold value Ath and a threshold value Eth used in comparison of the normalized dynamic range NDR_B are set in advance. In addition, a threshold value Bth used in comparison of the color variation amount Bv is set in advance. Further, a threshold value Cth used in comparison of the normalized dynamic range NDR_G is set in advance. Furthermore, a threshold value Dth used in comparison of a difference absolute value of the color variation amount Rv and the color variation amount Bv is set in advance.

If NDR_G>threshold value C, and Bv≧Bth, the tap mode 1 is selected. The tap mode 1 is a tap mode selected when a pixel value variation between the G component pixels in the designated region is great, and a color variation amount of the R component pixel is large.

If |Rv−Bv|≦Dth, and NDR_B≦Eth, the tap mode 2 is selected. The tap mode 2 is a tap mode selected when a color variation amount between the R component pixel and the B component pixel is small, and a difference between pixel values of the B component pixels is also small.

If NDR_B≧Ath, and Bv≧Bth, the tap mode 3 is selected. The tap mode 3 is a tap mode selected when a variation amount of a pixel value of only the B component is large and variation amounts of pixel values of the other color components are small in the designated region.

In a case which does not correspond to any of the above cases, the tap mode 0 is selected.

FIG. 9A is a diagram illustrating an example of the B class tap or the B prediction tap when the tap mode 0 is selected. In the example of FIG. 9A, a B component pixel closest to the central pixel on the obliquely upper right side, a B component pixel closest to the central pixel on the obliquely lower right side, and a B component pixel closest to the central pixel on the obliquely lower left side are acquired as taps. In addition, a prediction value Gp in each of cross-shaped five pixels on top and bottom and right and left sides including the central pixel is acquired as taps. In other words, in a case of the tap mode 0, three taps (pixels) of the input value B, and five taps (pixels) of the prediction values Gp are acquired.

In addition, the R component pixel is used as a central pixel here, but if the B component pixel is used as a central pixel, a position of a pixel serving as a reference is shifted to a position of the B component pixel close to the central pixel in relation to taps of the input value B. On the other hand, in relation of taps of the prediction value Gp, the taps are acquired in a cross shape centering on the B component pixel.

FIG. 9B is a diagram illustrating an example of the B class tap or the B prediction tap when the tap mode 1 is selected. In this example, in a case of the tap mode 0 and in a case of the tap mode 1, the B class tap or the B prediction tap is similarly acquired.

In addition, in the tap mode 0 and the tap mode 1, a structure of the B class tap or the B prediction tap is not changed, but a coefficient read from the B coefficient memory 107-3 is different.

FIG. 9C is a diagram illustrating an example of the B class tap or the B prediction tap when the tap mode 2 is selected. In addition, in the example of FIG. 9C, a prediction value Gp in each of cross-shaped five pixels on top and bottom and right and left sides including the central pixel is acquired as taps.

As described above, the tap mode 2 is a tap mode selected when a color variation amount between the R component pixel and the B component pixel is small, and a difference between pixel values of the B component pixels is also small. If a pixel of an output image is generated (predicted) on the basis of the pixel of the designated region, a false color tends to occur in the output image. For this reason, in the present technology, in a case where the tap mode 2 is selected, a pixel of the input value B is not used to generate a pixel of a B output image.

FIG. 9D is a diagram illustrating an example of the B class tap or the B prediction tap when the tap mode 3 is selected. In the example of FIG. 9D, a B component pixel closest the central pixel on the obliquely lower right side, and B component pixels respectively closest to the B component pixel on the horizontally right and left sides and the vertically upper and lower sides, are acquired as taps.

In addition, the R component pixel is used as a central pixel here, but if the B component pixel is used as a central pixel, a position of a pixel serving as a reference is shifted to a position of the B component pixel close to the central pixel in relation to taps of the input value R.

As described above, the tap mode 3 is a tap mode selected when a variation amount of a pixel value of only the B component is large and variation amounts of pixel values of the other color components are small in the designated region. If a pixel of an output image is generated (predicted) on the basis of the pixel of the designated region in the G output image, color bleeding or ringing tends to occur in the output image. For this reason, in the present technology, in a case where the tap mode 3 is selected, only a pixel of the input value B is used to generate a pixel of a B output image.

As described above, in the present technology, since a class tap or a prediction tap based on a color variation amount and a normalized dynamic range when an R output image and a B output image are generated, it is possible to suppress the occurrence of a false color, color bleeding, ringing, and the like.

Next, a description will be made of learning of coefficients stored in the G coefficient memory 107-1, the R coefficient memory 107-2, and the B coefficient memory 107-3.

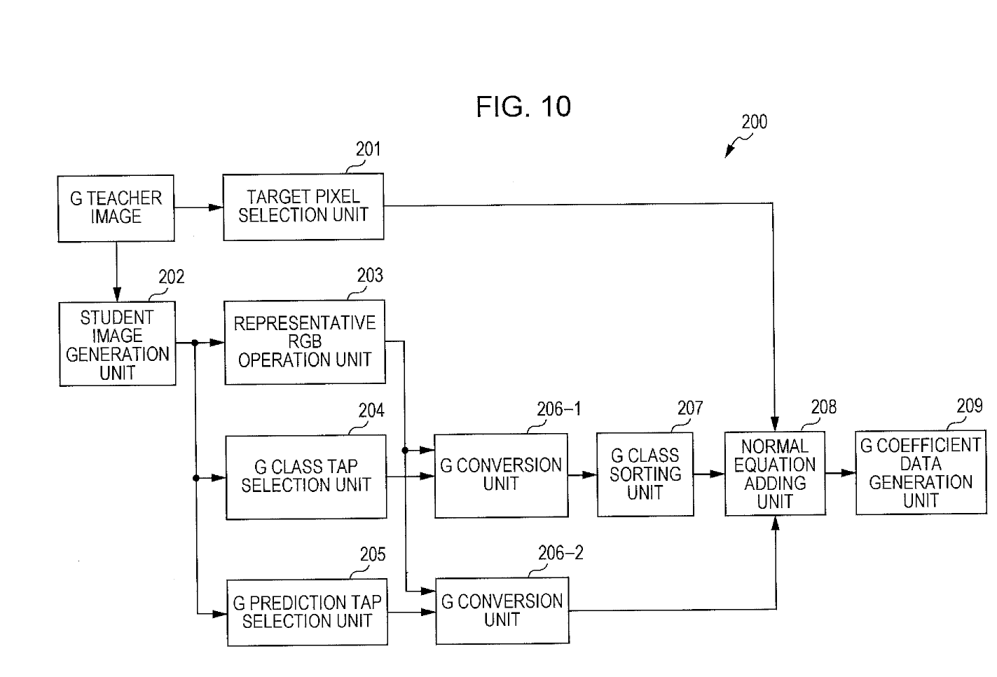

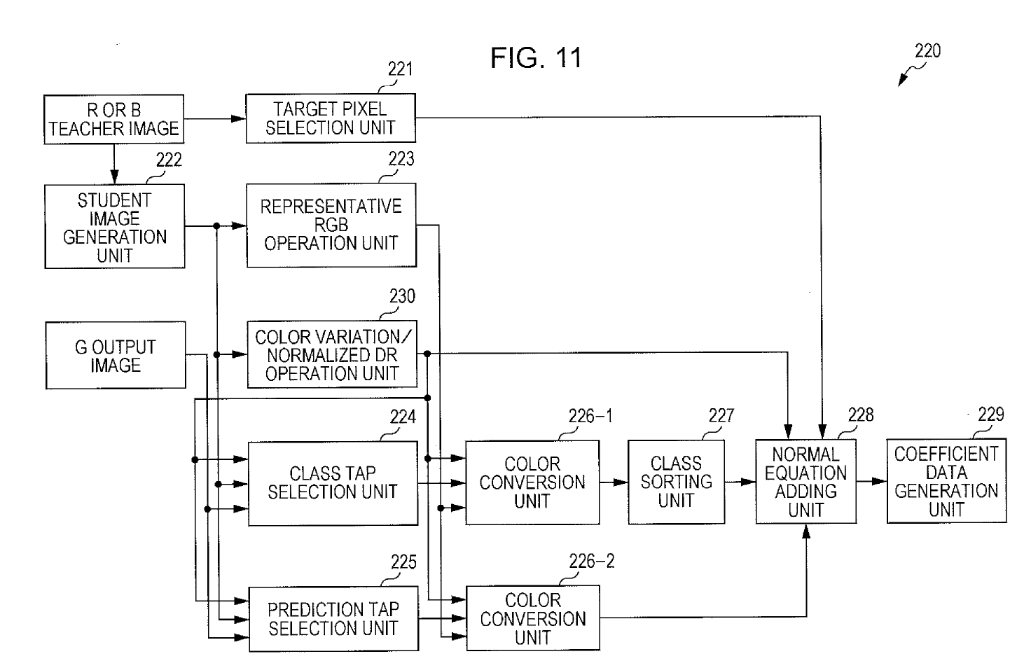

FIGS. 10 and 11 are block diagrams illustrating configuration examples of learning apparatuses corresponding to the image processing apparatus 100 of FIG. 2. FIG. 10 illustrates a configuration example of a learning apparatus 200 used to learn a coefficient stored in the G coefficient memory 107-1, and FIG. 11 illustrates a configuration example of a learning apparatus 220 used to learn coefficients stored in the R coefficient memory 107-2 and the B coefficient memory 107-3.

The learning apparatus 200 illustrated in FIG. 10 includes a target pixel selection unit 201, a student image generation unit 202, a representative RGB operation unit 203, a G class tap selection unit 204, a G prediction tap selection unit 205, a G color conversion unit 206-1, a G color conversion unit 206-2, a G class sorting unit 207, a normal equation adding unit 208, and a G coefficient data generation unit 209.

In a case where learning of a coefficient is performed in the learning apparatus 200, a G component image which is obtained, for example, by disposing an image sensors corresponding to an R component in the frame 14 of FIG. 1, is prepared as a teacher image.

The student image generation unit 202 makes the teacher image deteriorate by using, for example, a simulation model of an optical low-pass filter, and also generates an image output from an image sensor which includes pixels disposed according to the Bayer array. The image generated in this way is used as a student image.

The target pixel selection unit 201 selects any one pixel in the teacher image as a target pixel. In addition, a coordinate value and the like of a pixel selected as the target pixel is supplied to the representative ROB operation unit 203, the G class tap selection unit 204, and the G prediction tap selection unit 205.

The representative RGB operation unit 203 calculates a representative value Dg, a representative value Dr, and a representative value Db in relation to pixels in a designated region of the student image, in the same manner as the representative RGB operation unit 101 of FIG. 2. In addition, the designated region is set to a predetermined region centering on a pixel at a position corresponding to the target pixel selected by the target pixel selection unit 201.

The G class tap selection unit 204 selects and acquires a G class tap from pixels in the designated region of the student image.

The G prediction tap selection unit 205 selects and acquires a G prediction tap from the pixels in the designated region of the student image.

The G color conversion unit 206-1 performs a G conversion process on the class tap acquired by the G class tap selection unit 204.

The G class tap having undergone the process in the G color conversion unit 206-1 is supplied to the G class sorting unit 207.

The G color conversion unit 206-2 performs a G conversion process on the prediction tap acquired by the G prediction tap selection unit 205.

The prediction tap having undergone the process in the G color conversion unit 206-2 is supplied to the normal equation adding unit 208.

The G class sorting unit 207 codes the supplied class tap by using adaptive dynamic range coding (ADRC) so as to generate a class code. The class code generated here is supplied to the normal equation adding unit 208 along with the class tap.

The normal equation adding unit 208 generates the linear first order equation represented in, for example, the above Equation (4). At this time, the class tap having undergone the process in the color conversion process is used as the pixels x₁, x₂, . . . , and x_{N} of Equation (4).

If the target pixel selection unit 201 selects a new target pixel, a new linear first order equation is generated in the same manner in the above-described case. The normal equation adding unit 208 adds the linear first order equation to each class code so as to generate the normal equation of Equation (11).

The G coefficient data generation unit 209 solves the normal equation of Equation (11) with respect to the tap coefficient wₙ, by using, for example, a sweep-out method (Gauss-Jordan elimination). In addition, the coefficient data generation unit 209 outputs the obtained tap coefficient wₙ as a G coefficient necessary in performing a predictive operation of the G output image.

The G coefficient for each class code, obtained in this way, is stored in the G coefficient memory 107-1 of FIG. 2.

In this way, learning of the G coefficient is performed.

The learning apparatus 220 illustrated in FIG. 11 includes a target pixel selection unit 221, a student image generation unit 222, a representative RGB operation unit 223, a class tap selection unit 224, a prediction tap selection unit 225, a color conversion unit 226-1, a color conversion unit 226-2, a class sorting unit 227, a normal equation adding unit 228, and a coefficient data generation unit 229.

In a case where learning of a coefficient is performed in the learning apparatus 220, an R component image or a B component image, which is obtained, for example, by disposing an image sensor corresponding to an R component or a B component in the frame 14 of FIG. 1, is prepared as a teacher image. In addition, the acquisition of a teacher image in the learning apparatus 220 is performed by simultaneously photographing the same subject as a subject used for acquisition of the teacher image in the learning apparatus 200.

The student image generation unit 222 makes the teacher image deteriorate by using, for example, a simulation model of an optical low-pass filter, and also generates an image output from an image sensor which includes pixels disposed according to the Bayer array. The image generated in this way is used as a student image.

In addition, the student image generated by the student image generation unit 222 is used as an input image, and a G output image which is output by the image processing apparatus 100 of FIG. 2 is prepared using the G coefficient generated by the G coefficient data generation unit 209 of FIG. 10.

The target pixel selection unit 221 selects any one pixel in the teacher image as a target pixel. In addition, a coordinate value and the like of a pixel selected as the target pixel is supplied to the representative RGB operation unit 223, the class tap selection unit 224, and the prediction tap selection unit 225.

The representative RGB operation unit 223 calculates a representative value Dg, a representative value Dr, and a representative value Db in relation to pixels in a designated region of the student image, in the same manner as the representative RGB operation unit 101 of FIG. 2. In addition, the designated region is set to a predetermined region centering on a pixel at a position corresponding to the target pixel selected by the target pixel selection unit 221.

In the same manner as the color variation/normalized DR operation unit 110 of FIG. 2, a color variation/normalized DR operation unit 230 calculates a color variation amount of an R component pixel value for a G component pixel value and a color variation amount of a B component pixel value for the G component pixel value in the image sensor with the Bayer array. In addition, the color variation/normalized DR operation unit 230 calculates normalized dynamic ranges which is a value obtained by normalizing a dynamic range of the R component pixel value of the image sensor with the Bayer array, a value obtained by normalizing a dynamic range of the G component pixel value thereof, and a value obtained by normalizing a dynamic range of the B component pixel value thereof.

An output value from the color variation/normalized DR operation unit 230 is supplied to the class tap selection unit 224, the prediction tap selection unit 225, the color conversion unit 226-1, the color conversion unit 226-2, and the normal equation adding unit 228.

The class tap selection unit 224 selects and acquires a class tap from the pixels in the designated region of the student image or the G output image. In addition, in a case where the target pixel selection unit 221 selects the target pixel from the R component image of the teacher image, the class tap selection unit 224 selects an R class tap, and in a case where the target pixel selection unit 221 selects the target pixel from the B component image of the teacher image, the class tap selection unit 224 selects a B class tap.

The class tap selection unit 224 selects the above-described tap mode and acquires each class tap on the basis of the output value from the color variation/normalized DR operation unit 230.

The prediction tap selection unit 225 selects and acquires a prediction tap from the pixels in the designated region of the G output image. In addition, in a case where the target pixel selection unit 221 selects the target pixel from the R component image of the teacher image, the prediction tap selection unit 225 selects an R prediction tap, and in a case where the target pixel selection unit 221 selects the target pixel from the B component image of the teacher images, the prediction tap selection unit 225 selects a B prediction tap.

The prediction tap selection unit 225 selects the above-described tap mode and acquires each prediction tap on the basis of the output value from the color variation/normalized DR operation unit 230.

The color conversion unit 226-1 performs a predetermined conversion process on the class tap acquired by the class tap selection unit 224. Here, in a case where the R class tap is acquired by the class tap selection unit 224, the color conversion unit 226-1 performs the R conversion process thereon, and in a case where the B class tap is acquired by the class tap selection unit 224, the color conversion unit 226-1 performs the B conversion process thereon.

The class tap having undergone the process in the color conversion unit 226-1 is supplied to the class sorting unit 227.

The color conversion unit 226-2 performs a color conversion process on a prediction tap acquired by the prediction tap selection unit 225. Here, in a case where the R prediction tap is acquired by the prediction tap selection unit 225, the color conversion unit 226-2 performs the R conversion process thereon, and in a case where the B prediction tap is acquired by the prediction tap selection unit 225, the color conversion unit 226-2 performs the B conversion process thereon.

The prediction tap having undergone the process in the color conversion unit 226-2 is supplied to the normal equation adding unit 228.

The class sorting unit 227 codes the supplied class tap by using adaptive dynamic range coding (ADRC) so as to generate a class code. The class code generated here is supplied to the normal equation adding unit 228 along with the class tap.

The normal equation adding unit 228 generates the linear first order equation represented in, for example, the above Equation (4). At this time, the class tap having undergone the process in the color conversion process is used as the pixels x₁, x₂, . . . , and x_{N} of Equation (4).

If the target pixel selection unit 221 selects a new target pixel, a new linear first order equation is generated in the same manner in the above-described case. The normal equation adding unit 228 adds the linear first order equation to each class code so as to generate the normal equation of Equation (11).

The coefficient data generation unit 229 solves the normal equation of Equation (11) with respect to the tap coefficient wₙ, by using, for example, a sweep-out method (Gauss-Jordan elimination). In addition, the coefficient data generation unit 229 outputs the obtained tap coefficient wₙ as an R coefficient necessary in performing a predictive operation of the R output image, or as a B coefficient necessary in performing a predictive operation of the B output image, on the basis of the kind of teacher image (the R component image or the B component image) where the target pixel is set.

The G coefficient, the R coefficient or and the B coefficient for each tap mode and each class code, obtained in this way, are respectively stored in the R coefficient memory 107-2 or the B coefficient memory 107-3 of FIG. 2.

In this way, learning of the R coefficient or the B coefficient is performed.

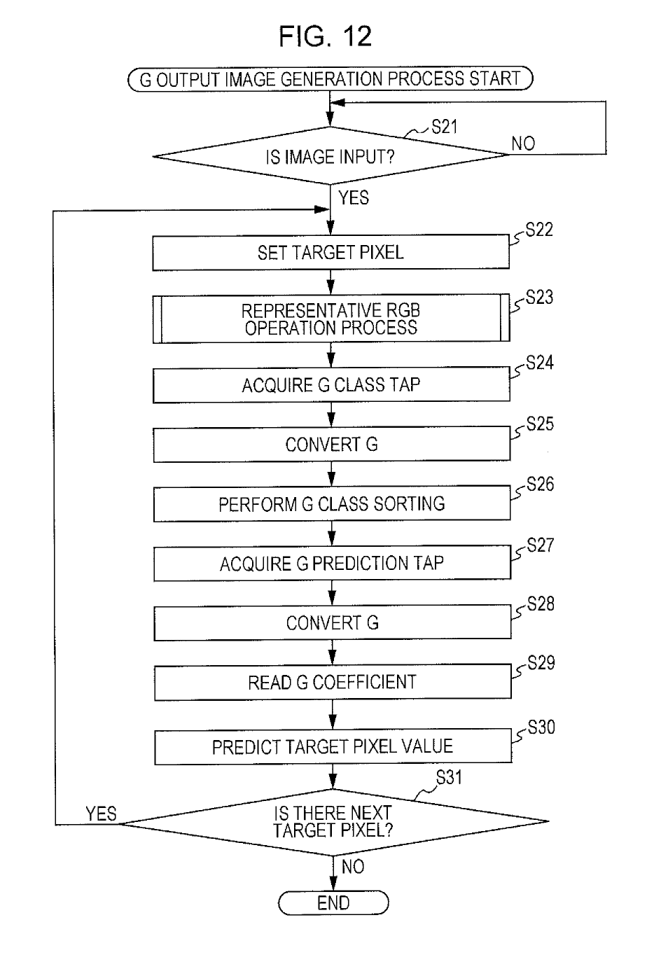

FIG. 12 is a flowchart illustrating an example of a G output image generation process, related to the generation of the G output image performed by the image processing apparatus 100 of FIG. 2.

In step S21, it is determined whether or not an image (input image) which is a target of the image process is input, and waiting is performed until it is determined that the image is input. If it is determined that the image is input in step S21, the process proceeds to step S22.

In addition, as described above, the input image is an image which is formed by output values of the image sensor using, for example, a color filter array with the Bayer array. Therefore, in the input image, an R component image signal is obtained from a pixel in which an R filter is disposed, but G component and B component image signals are not be obtained therefrom. Similarly, only a G component image signal is obtained from a G pixel, and R component and B component image signals are not obtained therefrom. Only a B component image signal is obtained from a B pixel, and R component and G component image signals are not obtained therefrom.

In step S22, a target pixel is set. Accordingly, a central pixel in the input image is determined.

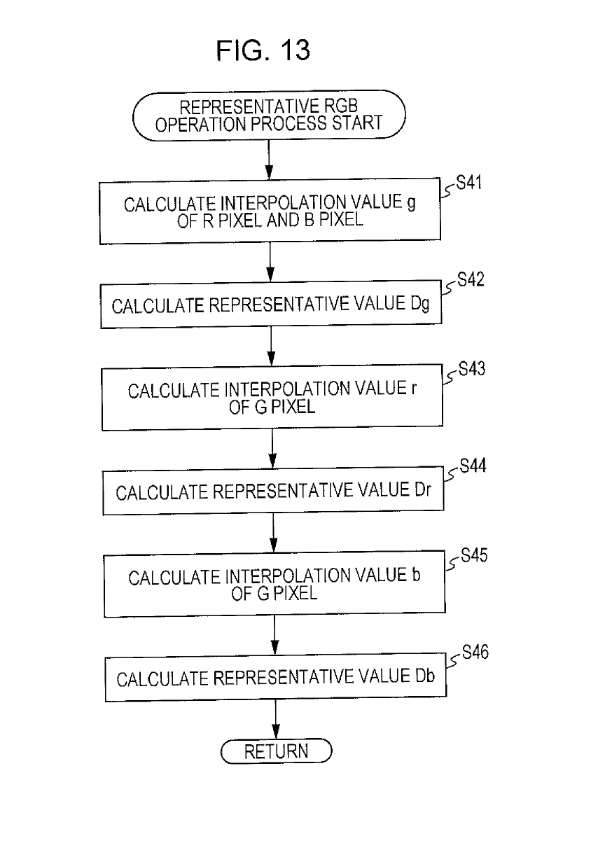

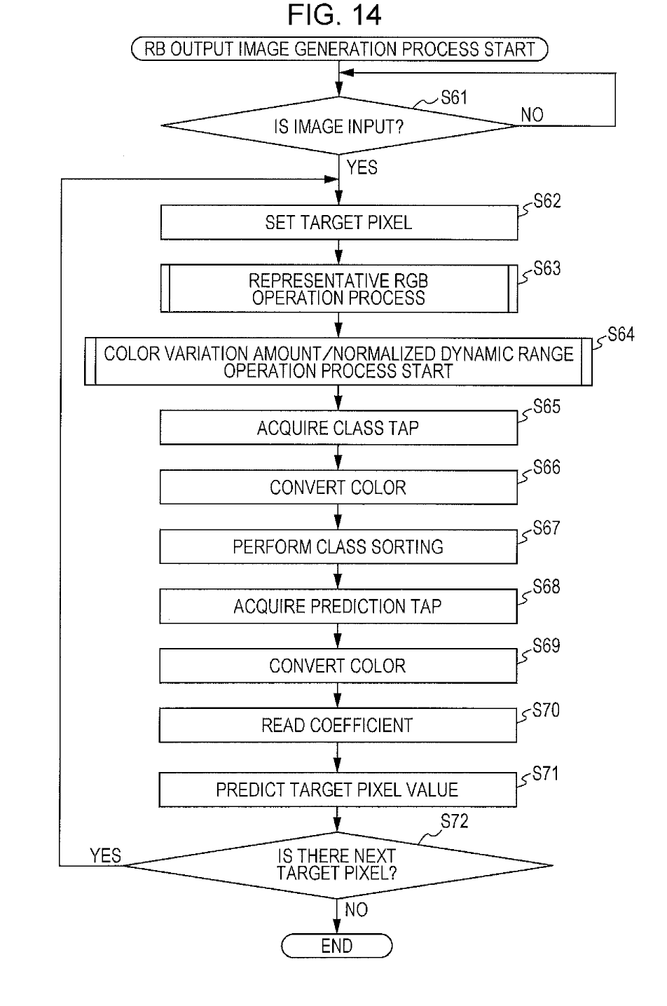

In step $23, the representative RGB operation unit 101 performs a representative RGB operation process described later with reference to FIG. 13. Accordingly, the above-described representative value Dg, representative value Dg, and representative value Db are operated.

In step S24, the G class tap selection unit 102-1 acquires a G class tap.

In step S25, the G conversion unit 105-11 performs the G conversion. At this time, the conversion value G′, the conversion value R′, and the conversion value B′ are operated using the above Equations (1) to (3).

In step S26, G class sorting is performed. For example, in a case of generating the G output image, the G class sorting unit 106-1 codes the supplied G class tap by using adaptive dynamic range coding (ADRC), so as to generate a class code, thereby performing the class sorting.

In step S27, the G prediction tap selection unit 103-1 acquires a G prediction tap.

In step S28, the G conversion unit 105-12 performs the G conversion. At this time, the conversion value G′, the conversion value R′, and the conversion value B′ are operated using the above Equations (1) to (3).

In step S29, a coefficient, which is stored in correlation with the class code generated due to the process in step S26, is read from the G coefficient memory 107-1.

In step S30, a target pixel value is predicted. At this time, the G prediction tap having undergone the color conversion due to the process in step S28 is assigned to the pixels x₁, x₂, . . . , and x_{N} of Equation (4), the coefficient read due to the process in step S29 is supplied as the tap coefficient wₙ of Equation (4), and then the operation of Equation (4) is performed by the G product-sum operation unit 108-1, thereby predicting a pixel value of the target pixel of the output image.

In step S31, it is determined whether or not there is the next target pixel, and if it is determined that there is the next target pixel, the process returns to step S22, and the subsequent processes are repeatedly performed.

If it is determined that there is no next target pixel in step S31, the process ends.

In this way, the G output image generation process is performed.

Next, with reference to a flowchart of FIG. 13, a specific example of the representative RGB operation process in step S23 of FIG. 12 will be described.

In step S41, the representative RGB operation unit 101 calculates an interpolation value g of the R component pixel and the B component pixel in the designated region of the input image. At this time, for example, as illustrated in FIG. 4, the R component pixel or the B component pixel in the designated region is used as a central pixel, and an input value G1 to an input value G4 of the pixel G1 to the pixel G4 which are four peripheral pixels (top and bottom and right and left) of the central pixel are averaged, thereby calculating the interpolation value g which is a value of the G component interpolated at the pixel position of the central pixel.

In step S42, the representative RGB operation unit 101 calculates a representative value Dg. At this time, an average value of input values G of all the G pixels and the interpolation value g calculated in step S41 is calculated as a representative value Dg.

In step S43, the representative RGB operation unit 101 calculates an interpolation value r of the G component pixel. For example, in a case of calculating the interpolation value r at the position of the pixel G1 or the pixel G4 of FIG. 4, as illustrated in FIG. 5, an average value of the pixel R2 and the pixel R1 which are adjacent to the G pixel on both of right and left sides is regarded as the interpolation value r.

Accordingly, the input value G and the interpolation value r can be obtained at the pixel position of the G pixel in the designated region, and an input value R and an interpolation value g can be obtained at the pixel position of the R pixel in the designated region.

In step S44, the representative RGB operation unit 101 calculates a representative value Dr. At this time, (interpolation value r−input value G) and (input value R−interpolation value g) are calculated at each pixel position, and a value obtained by adding the representative value Dg to an average value of the calculated (interpolation value r−input value G) and (input value R−interpolation value g) is calculated as the representative value Dr.

In step S45, the representative RGB operation unit 101 calculates an interpolation value b of the G component pixel. For example, in a case of calculating the interpolation value b at the position of the pixel G1 or the pixel G4 of FIG. 4, as illustrated in FIG. 6, an average value of the pixel B1 and the pixel B2 which are adjacent to the G pixel on both of top and bottom sides is regarded as the interpolation value b.

Accordingly, the input value G and the interpolation value b can be obtained at the pixel position of the G pixel in the designated region, and an input value B and an interpolation value g can be obtained at the pixel position of the B pixel in the designated region.

In step S46, the representative RGB operation unit 101 calculates a representative value Db. At this time, (interpolation value b−input value G) and (input value B−interpolation value g) are calculated at each pixel position, and a value obtained by adding the representative value Dg to an average value of the calculated (interpolation value b−input value G) and (input value B−interpolation value g) is calculated as the representative value Db.

In this way, the representative RGB operation process is performed.

FIG. 14 is a flowchart illustrating an example of an RB output image generation process related to the generation of an R output image and a B output image performed by the image processing apparatus 100 of FIG. 2.

In step S61, it is determined whether or not an image (input image) which is a target of the image process is input, and waiting is performed until it is determined that the image is input. If it is determined that the image is input in step S61, the process proceeds to step S62.

In addition, as described above, the input image is an image which is formed by output values of the image sensor using, for example, a color filter array with the Bayer array. Therefore, in the input image, an R component image signal is obtained from a pixel in which an R filter is disposed, but G component and B component image signals are not be obtained therefrom. Similarly, only a G component image signal is obtained from a G pixel, and R component and B component image signals are not obtained therefrom. Only a B component image signal is obtained from a B pixel, and R component and G component image signals are not obtained therefrom.

In step S62, a target pixel is set. Accordingly, a central pixel in the input image and the G output image is determined.

In step S63, the representative ROB operation unit 101 performs a representative RGB operation process described with reference to FIG. 13. Accordingly, the above-described representative value Dg, representative value Dg, and representative value Db are operated.

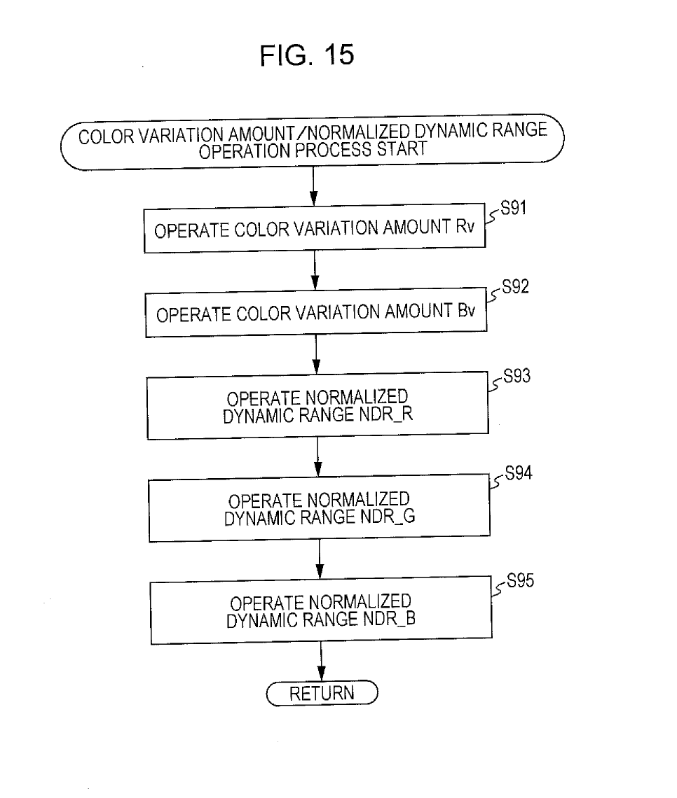

In step S64, the color variation/normalized DR operation unit 110 operates a color variation amount/normalized dynamic range operation process described with reference to FIG. 15. Accordingly, a color variation amount is calculated which is a variation amount of an R component pixel value for a G component pixel value and a variation amount of a B component pixel value for the G component pixel value of the image sensor with the Bayer array. In addition, normalized dynamic ranges are calculated which include a value obtained by normalizing a dynamic range of the R component pixel value of the image sensor with the Bayer array, a value obtained by normalizing a dynamic range of the G component pixel value thereof, and a value obtained by normalizing a dynamic range of the B component pixel value thereof.

In step S65, the R class tap selection unit 102-2, or the B class tap selection unit 102-3 respectively acquires an R class tap, or a B class tap.

In a case where an R output image is generated, the R class tap is acquired. In a case where a B output image is generated, the B class tap is acquired. In addition, at this time, as described with reference to FIGS. 8A to 9D, a tap mode is selected, and the R class tap or the B class tap is acquired.

In step S66, color conversion is performed. For example, in a case of generating the R output image, the R conversion unit 105-21 performs the R conversion. At this time, the conversion value Gp′ is operated using the above Equation (12). In addition, in a case of generating the B output image, the B conversion unit 105-31 performs the B conversion. At this time, the conversion value Gp′ is operated using the above Equation (13).

In step S67, class sorting is performed. For example, in a case of generating the R output image, the R class sorting unit 106-2 codes the supplied R class tap by using adaptive dynamic range coding (ADRC), so as to generate a class code, thereby performing the class sorting. In addition, in a case of generating the B output image, the B class sorting unit 106-3 codes the supplied B class tap by using adaptive dynamic range coding (ADRC), so as to generate a class code, thereby performing the class sorting.

In addition, information for specifying the tap mode selected when acquiring the class tap in step S65 is added to the class code.

In step S68, a prediction tap is acquired. For example, in a case of generating the R output image, the R prediction tap selection unit 103-2 acquires an R prediction tap, and in a case of generating the B output image, the B prediction tap selection unit 103-3 acquires a B prediction tap. In addition, at this time, as described with reference to FIGS. 8A to 9D, a tap mode is selected, and the R prediction tap or the B prediction tap is acquired.

In step S69, color conversion is performed. For example, in a case of generating the R output image, the R conversion unit 105-22 performs the R conversion. At this time, the conversion value Gp′ is operated using the above Equation (12). In addition, in a case of generating the B output image, the B conversion unit 105-32 performs the B conversion. At this time, the conversion value Gp′ is operated using the above Equation (13).

In step S70, a coefficient is read. For example, in a case of generating the R output image, the R coefficient, which is stored in correlation with the class code generated due to the process in step S67, and the tap mode selected due to the process in step S65 or step S68, is read from the R coefficient memory 107-2. In addition, in a case of generating the B output image, the B coefficient, which is stored in correlation with the class code and the tap mode, is read from the B coefficient memory 107-3.

In step S71, a target pixel value is predicted. For example, in a case of generating the R output image, the R prediction tap having undergone the R conversion due to the process in step S69 is assigned to the pixels x₁, x₂, . . . , and x_{N} of Equation (4), the R coefficient read due to the process in step S70 is supplied as the tap coefficient wₙ of Equation (4), and then the operation of Equation (4) is performed by the R product-sum operation unit 108-2, thereby predicting a pixel value of the target pixel of the output image. In addition, in a case of generating the B output image, the B prediction tap having undergone the R conversion due to the process in step S69 is assigned to the pixels x₁, x₂, . . . , and x_{N} of Equation (4), the B coefficient read due to the process in step S70 is supplied as the tap coefficient wₙ of Equation (4), and then the operation of Equation (4) is performed by the B product-sum operation unit 108-3, thereby predicting a pixel value of the target pixel of the output image.

In step S72, it is determined whether or not there is the next target pixel, and if it is determined that there is the next target pixel, the process returns to step S62, and the subsequent processes are repeatedly performed.

If it is determined that there is no next target pixel in step S72, the process ends.

In this way, the RB output image generation process is performed.

Next, with reference to a flowchart of FIG. 15, a specific example of the color variation amount/normalized dynamic range operation process of step S64 of FIG. 14 will be described.

In step S91, the color variation/normalized DR operation unit 110 calculates a color variation amount Rv related to the R component pixel. At this time, a value, which is obtained by multiplying a dynamic range of a difference value between the input value R of the R component pixel of the designated region and the interpolation value g by 256/Dg, is calculated as the color variation amount Rv.

In step S92, the color variation/normalized DR operation unit 110 calculates a color variation amount Bv related to the B component pixel. At this time, a value, which is obtained by multiplying a dynamic range of a difference value between the input value B of the B component pixel of the designated region and the interpolation value g by 256/Dg, is calculated as the color variation amount Bv.

In step S93, the color variation/normalized DR operation unit 110 calculates a normalized dynamic range NDR_R related to the R component pixel. At this time, a value, which is obtained by dividing a dynamic range DR_R of the input value R in the designated region by an average value of the input value R in the designated region, is calculated as the normalized dynamic range NDR_R.

In step S94, the color variation/normalized DR operation unit 110 calculates a normalized dynamic range NDR_G related to the G component pixel. At this time, a value, which is obtained by dividing a dynamic range DR_G of the input value G in the designated region by an average value of the input value G in the designated region, is calculated as the normalized dynamic range NDR_G.

In step S95, the color variation/normalized DR operation unit 110 calculates a normalized dynamic range NDR_B related to the B component pixel. At this time, a value, which is obtained by dividing a dynamic range DR_B of the input value B in the designated region by an average value of the input value B in the designated region, is calculated as the normalized dynamic range NDR_B.

In this way, the color variation amount/normalized dynamic range is performed.

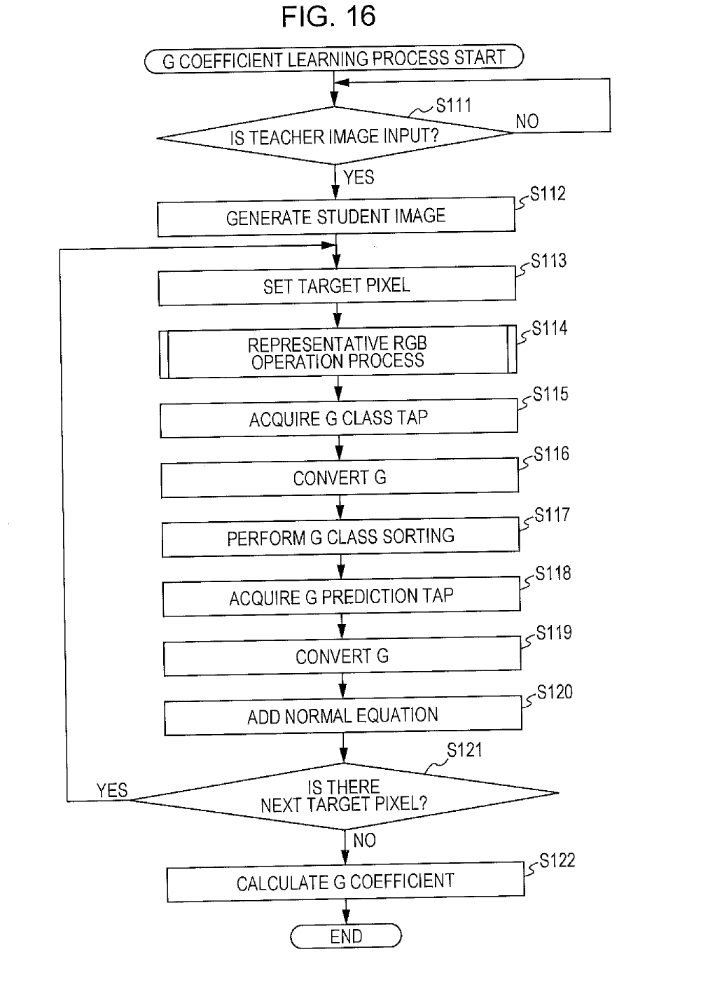

Next, a description will be made of an example of a G coefficient learning process related to learning of the G coefficient performed by the learning apparatus 200 of FIG. 10 with reference to a flowchart of FIG. 16.

In step S111, it is determined whether or not a teacher image is input, and waiting is performed until it is determined that the teacher image is input. If it is determined that the teacher image is input in step S111, the process proceeds to step S112.

As described above, the teacher image is a G component image which is obtained, for example, by disposing an image sensor corresponding to a G component in the frame 14 of FIG. 1.

In step S112, the student image generation unit 202 generates a student image. At this time, the teacher images are made to deteriorate by using, for example, a simulation model of an optical low-pass filter, and an image output from an image sensor which includes pixels disposed according to the Bayer array is generated and used as the student image.

In step S113, the target pixel selection unit 201 selects (sets) any one pixel in the teacher image as a target pixel. Accordingly, a central pixel in the student image is determined.

In step S114, the representative RGB operation unit 203 performs the representative RGB operation process described with reference to the flowchart of FIG. 13. Accordingly, the representative value Dg, the representative value Dr, and the representative value Db are calculated.

In step S115, the G class tap selection unit 204 selects and acquires a G class tap from the pixels in the designated region of the student image.

In step S116, the G color conversion unit 206-1 performs the G conversion process on the G class tap acquired due to the process in step S115.

In step S117, the G class sorting unit 207 codes the supplied class tap by using adaptive dynamic range coding (ADRC) so as to generate a class code. The class code generated here is supplied to the normal equation adding unit 208 along with the class tap.

In step S118, the G prediction tap selection unit 205 selects and acquires a G prediction tap from the pixels in the designated region of the student image.

In step S119, the G color conversion unit 206-2 performs the G conversion process on the G prediction tap acquired due to the process in step S118.

In step S120, the normal equation adding unit 208 performs addition of the normal equation.

As described above, the normal equation adding unit 208 generates the linear first order equation represented in, for example, the above Equation (4), and the class tap having undergone the process in the G conversion unit is used as the pixels x₁, x₂, . . . , and x_{N} of Equation (4). In addition, the normal equation adding unit 208 adds the linear first order equation generated in this way to each class code generated due to the process in step S117 so as to generate the normal equation of Equation (11).

In step S121, it is determined whether or not there is the next target pixel, and if it is determined that there is the next target pixel, the process returns to step S113, and the subsequent processes are repeatedly performed.

On the other hand, if it is determined that there is no next target pixel in step S121, the process proceeds to step S122.

In step S122, the G coefficient data generation unit 209 calculates a coefficient.

At this time, as described above, the G coefficient data generation unit 209 solves the normal equation of Equation (ii) with respect to the tap coefficient wₙ, by using, for example, a sweep-out method (Gauss-Jordan elimination). In addition, the coefficient data generation unit 209 outputs the obtained tap coefficient wₙ as a G coefficient necessary in performing a predictive operation of the G output image.

The G coefficient for each class code obtained in this way is stored in the G coefficient memory 107-1 of FIG. 2, and is read due to the process in step S29 of FIG. 12.

In this way, the G coefficient learning process is performed.

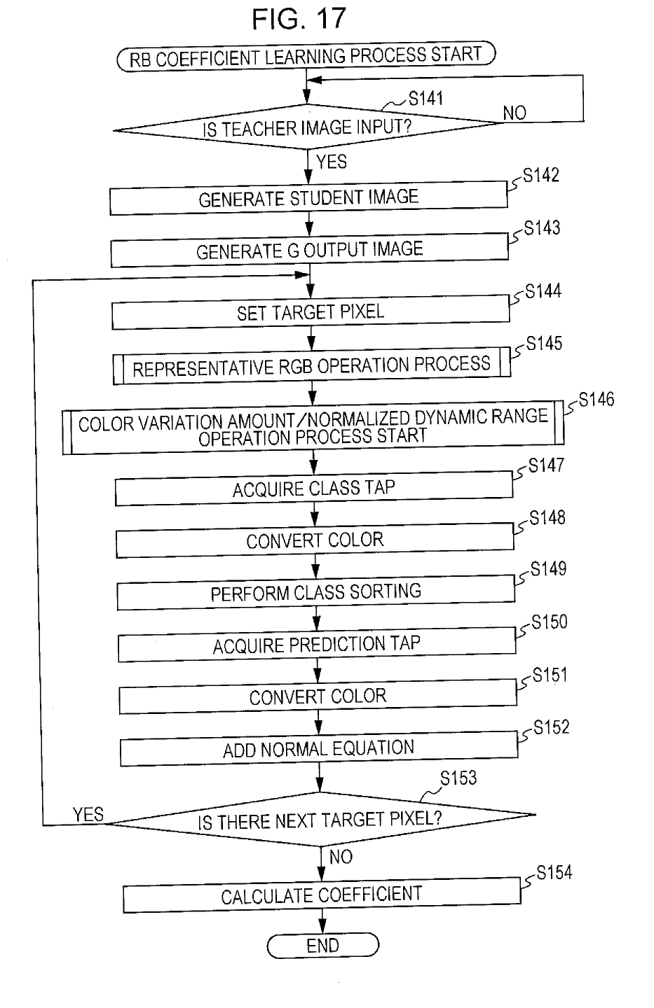

Next, a description will be made of an example of an RB coefficient learning process related to learning of an R coefficient and a B coefficient performed by the learning apparatus 220 of FIG. 11 with reference to a flowchart of FIG. 17.

In step S141, it is determined whether or not teacher images are input, and waiting is performed until it is determined that the teacher images are input. If it is determined that the teacher images are input in step S141, the process proceeds to step S142.

As described above, the teacher images are a G component image, an R component image, and a B component image, which are obtained, for example, by disposing two image sensors respectively corresponding to an R component, and a B component in the frame 14 of FIG. 1.

In step S142, the student image generation unit 222 generates a student image. At this time, the teacher images are made to deteriorate by using, for example, a simulation model of an optical low-pass filter, and an image output from an image sensor which includes pixels disposed according to the Bayer array is generated and used as the student image.

In step S143, the student image generated due to the process in step S142 is used as an input image, and a G output image which is output by the image processing apparatus 100 of FIG. 2 is prepared using the G coefficient calculated due to the process in step S122 of FIG. 16.

In step S144, the target pixel selection unit 221 selects any one pixel in the teacher image as a target pixel. In addition, a coordinate value and the like of a pixel selected as the target pixel is supplied to the representative RGB operation unit 223, the class tap selection unit 224, and the prediction tap selection unit 225.

In step S145, the representative RGB operation unit performs the representative RGB operation process described with reference to the flowchart of FIG. 13. Accordingly, the representative value Dg, the representative value Dr, and the representative value Db are calculated.

In step S146, the color variation/normalized DR operation unit 110 the color variation amount/normalized dynamic range operation process described with reference to FIG. 15. Accordingly, color variation amounts are calculated which include a variation amount of an R component pixel value for a G component pixel value and a variation amount of a B component pixel value for the G component pixel value of the image sensor with the Bayer array. In addition, normalized dynamic ranges are calculated which include a value obtained by normalizing a dynamic range of the R component pixel value of the image sensor with the Bayer array, a value obtained by normalizing a dynamic range of the G component pixel value thereof, and a value obtained by normalizing a dynamic range of the B component pixel value thereof.

In step S147, the class tap selection unit 224 selects and acquires a class tap from the pixels in the designated region of the G output image. Further, in a case where the target pixel is selected from the R component image of the teacher images in step S144, an R class tap is selected in step S147, and in a case where the target pixel is selected from the B component image of the teacher images in step S144, a B class tap is selected in step S147.

In addition, in step S147, the class tap selection unit 224 selects the above-described tap mode and each class tap on the basis of an output value from the color variation/normalized DR operation unit 230.

In step S148, the color conversion unit 226-1 performs a color conversion process on the class tap acquired by the class tap selection unit 224. In addition, in a case where the R class tap is acquired in step S147, the R conversion process is performed thereon in step S148, and in a case where the B class tap is acquired in step S147, the B conversion process is performed thereon in step S148.

In step S149, the class sorting unit 227 codes the supplied class tap by using adaptive dynamic range coding (ADRC) so as to generate a class code. In addition, information for specifying the tap mode selected when acquiring the class tap in step S147 is added to the class code.

In step S150, the prediction tap selection unit 225 selects and acquires a prediction tap from the pixels in the designated region of the student image or the G output image. Further, in a case where the target pixel is selected from the R component image of the teacher images in step S144, an R prediction tap is selected in step S150, and in a case where the target pixel is selected from the B component image of the teacher images in step S144, a B prediction tap is selected in step S150.

In addition, in step S150, the prediction tap selection unit 225 selects the above-described tap mode and each prediction tap on the basis of an output value from the color variation/normalized DR operation unit 230.

In step S151, the color conversion unit 226-2 performs a color conversion process on the prediction tap acquired by the prediction tap selection unit 225. In addition, in a case where the R prediction tap is acquired in step S150, the R conversion process is performed thereon in step S151, and in a case where the B prediction tap is acquired in step S150, the B conversion process is performed thereon in step S151.

In step S152, the normal equation adding unit 228 performs addition of the normal equation.

As described above, the normal equation adding unit 228 generates the linear first order equation represented in, for example, the above Equation (4), and the class tap having undergone the process in the color conversion unit is used as the pixels x₁, x₂, . . . , and x_{N} of Equation (4). In addition, the normal equation adding unit 228 adds the linear first order equation generated in this way to each class code generated due to the process in step S149 and to each tap mode selected due to the process in step S147 or step S150 so as to generate the normal equation of Equation (11).

In step S153, it is determined whether or not there is the next target pixel, and if it is determined that there is the next target pixel, the process returns to step S144, and the subsequent processes are repeatedly performed.

On the other hand, if it is determined that there is no next target pixel in step S153, the process proceeds to step S154.

In step S154, the coefficient data generation unit 229 calculates an R coefficient and a B coefficient.

The R coefficient and the B coefficient for the respective class codes and tap modes, obtained in this way, are respectively stored in the R coefficient memory 107-2 and the B coefficient memory 107-3 of FIG. 2, and are read due to the process in step S70 of FIG. 14.

In this way, the RB coefficient learning process is performed.

In the example described with reference to FIG. 2, a description has been made that a pixel value is replaced with a conversion value through the color conversion, and undergoes the class sorting and the product-sum operation, but, for example, a pixel value may be replaced with a color difference and may undergo the class sorting and the product-sum operation.

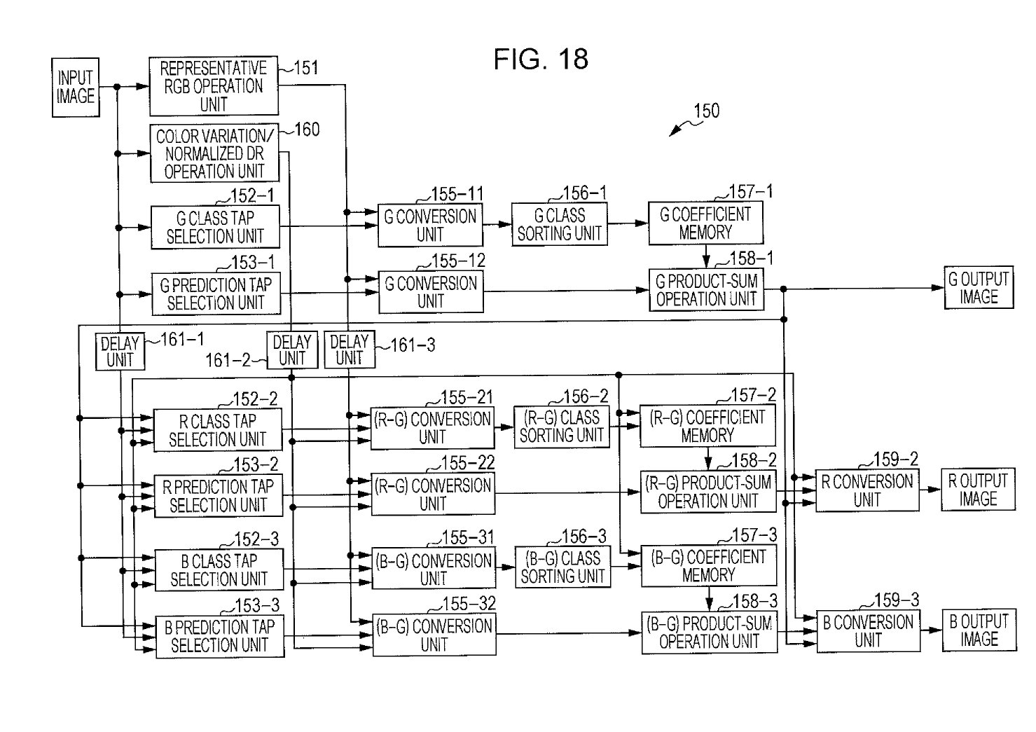

FIG. 18 is a block diagram illustrating a configuration example according to another embodiment of an image processing apparatus to which the present technology is applied. An image processing apparatus 150 illustrated in FIG. 18 replaces a pixel value with a color difference and performs class sorting and a product-sum operation thereon when generating an R output image and a B output image by using a generated G output image.

A representative RGB operation unit 151 of FIG. 18 has the same configuration as the representative RGB operation unit 101 of FIG. 2, and thus detailed description thereof will not be repeated.

In FIG. 18, a functional block related to generation of the G output image, that is, a G class tap selection unit 152-1, a G conversion unit 155-11, a G class sorting unit 156-1, a G coefficient memory 157-1, a G prediction tap selection unit 153-1, a G conversion unit 155-12, and a G product-sum operation unit 158-1 respectively have the same configurations as the G class tap selection unit 102-1, the G conversion unit 105-11, the G class sorting unit 106-1, the G coefficient memory 107-1, the G prediction tap selection unit 103-1, the G conversion unit 105-12, and the G product-sum operation unit 108-1 of FIG. 2, and thus detailed description thereof will not be repeated.

In a case of the configuration of FIG. 18, an input image is supplied to an R class tap selection unit 152-2 and an R class tap selection unit 153-2, and a B class tap selection unit 152-3 and a B prediction tap selection unit 153-3 via a delay unit 161-1.

In addition, in a case of the configuration of FIG. 18, data output from the G product-sum operation unit 158-1 is supplied to an R conversion unit 159-2 and a B conversion unit 159-3 via the delay unit 161-1.

Further, in a case of the configuration of FIG. 18, data output from a color variation/normalized DR operation unit 160 is supplied to the R class tap selection unit 152-2 and the R prediction tap selection unit 153-2, and the B class tap selection unit 152-3 and the B prediction tap selection unit 153-3, via a delay unit 161-2. Furthermore, the data output from the color variation/normalized DR operation unit 160 is supplied to a (R−G) conversion unit 155-21 and a (R−G) conversion unit 155-22, and a (B−G) conversion unit 155-31 and a (B−G) conversion unit 155-32, via the delay unit 161-2. Moreover, the data output from the color variation/normalized DR operation unit 160 is supplied to a (R−G) coefficient memory 157-2 and a (B−G) coefficient memory 157-3, a (B−G) conversion unit, and an R conversion unit 159-2 and a B conversion unit 159-3, via the delay unit 161-2.

In addition, in a case of the configuration of FIG. 18, data output from the representative RGB operation unit 151 is supplied to the (R−G) conversion unit 155-21 and the (R−G) conversion unit 155-22, and the (B−G) conversion unit 155-31 and the (B−G) conversion unit 155-32, via a delay unit 161-3.

In addition, in a case of employing the configuration of FIG. 18, structures of an R class tap, a B class tap, an R prediction tap, and a B prediction tap are different from those described with reference to FIGS. 8A to 9D. Also in a case of employing the configuration of FIG. 18, structures of a G class tap and a G prediction tap are the same as those described with reference to FIG. 7.

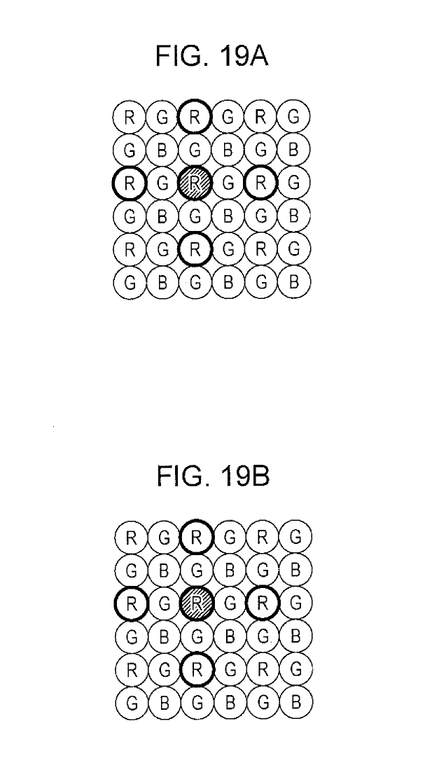

FIGS. 19A and 19B are diagrams illustrating examples of an R class tap and an R prediction tap in a case of employing the configuration of FIG. 18. In addition, in a case of employing the configuration of FIG. 18, the tap mode 0 or 1 is selected on the basis of an output value from the color variation/normalized DR operation unit 160.

FIG. 19A is a diagram illustrating an example of an R class tap or an R prediction tap when the tap mode 0 is selected. In the example illustrated in FIG. 19A, cross-shaped five R component pixels on top and bottom and right and left sides including the central pixel are acquired as taps. In other words, in a case of the tap mode 0, five taps (pixels) of the input value R are acquired.

In addition, the R component pixel is used as a central pixel here, but if the G component or B component pixel is used as a central pixel, a position of a pixel serving as a reference of the tap is shifted to a position of the R component pixel close to the central pixel.

FIG. 19B is a diagram illustrating an example of the R class tap or the R prediction tap when the tap mode 1 is selected. In this example, in a case of the tap mode 0 and in a case of the tap mode 1, the R class tap or the R prediction tap is similarly acquired.

In this example, in the tap mode 0 and the tap mode 1, a structure of the R class tap or the R prediction tap is not changed, but a coefficient read from the (R−G) coefficient memory 157-2 is different.

In addition, the class tap and the prediction tap may or may not have the same structure.

The R class tap and the R prediction tap acquired in this way are respectively supplied to the (R−G) conversion unit 155-21 and the (R−G) conversion unit 155-22.

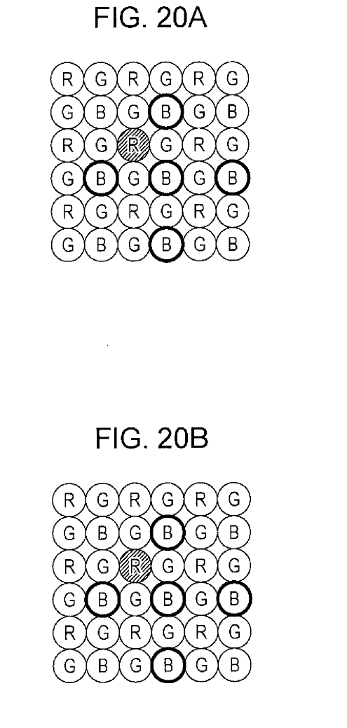

FIGS. 20A and 20B are diagrams illustrating examples of a B class tap and a B prediction tap in a case of employing the configuration of FIG. 18. In addition, in a case of employing the configuration of FIG. 18, the tap mode 0 or 1 is selected on the basis of an output value from the color variation/normalized DR operation unit 160.

FIG. 20A is a diagram illustrating an example of a B class tap or a B prediction tap when the tap mode 0 is selected. In the example illustrated in FIG. 20A, cross-shaped five R component pixels on top and bottom and right and left sides with respect to a B component pixel closest to the central pixel on the obliquely lower side are acquired as taps. In other words, in a case of the tap mode 0, five taps (pixels) of the input value B are acquired.

In addition, the R component pixel is used as a central pixel here, but if the B component pixel is used as a central pixel, a position of a pixel serving as a reference of the tap is shifted to a position of the B component pixel close to the central pixel.

FIG. 20B is a diagram illustrating an example of the B class tap or the B prediction tap when the tap mode 1 is selected. In this example, in a case of the tap mode 0 and in a case of the tap mode 1, the B class tap or the B prediction tap is similarly acquired.

In this example, in the tap mode 0 and the tap mode 1, a structure of the B class tap or the B prediction tap is not changed, but a coefficient read from the (B−G) coefficient memory 157-3 is different.

In addition, the class tap and the prediction tap may or may not have the same structure.

The B class tap and the B prediction tap acquired in this way are respectively supplied to the (B−G) conversion unit 155-31 and the (B−G) conversion unit 155-32.

In a case of employing the configuration of FIG. 18, a tap mode for generating an R output image is selected as follows.

In a case where a tap mode is selected when generating the R output image, a threshold value Ath used in comparison of the normalized dynamic range NDR_R, and a threshold value Bth used in the color variation amount Rv are set in advance.

If NDR_R≧Ath, and Rv≧Bth, the tap mode 1 is selected. The tap mode 1 is a tap mode selected when a variation amount of a pixel value and a color variation amount of only the R component are large and variation amounts of pixel values and color variation amounts of the other color components are small in the designated region.

In a case which does not correspond to the above case, the tap mode 0 is selected.

In a case of the configuration of FIG. 18, the (R−G) conversion unit 155-21 and the (R−G) conversion unit 155-22 are controlled so as to perform or stop an operation on the basis of the tap mode.

In a case of the tap mode 1, the (R−G) conversion unit 155-21 performs a (R−G) conversion process on each pixel value forming the R class tap, and a virtual color difference is calculated due to the (R−G) conversion process. In other words, the (R−G) conversion unit 155-21 performs an operation of Equation (14) on each pixel value forming the R class tap so as to calculate a virtual color difference RGc.

RGc=R−g (14)

In addition, the interpolation value g in Equation (14) is supplied from the representative RGB operation unit 151.

On the other hand, in a case of the tap mode 0, the (R−G) conversion unit 155-21 outputs the R class tap to the (R−G) class sorting unit 156-2 as it is without performing the operation of Equation (14).

In this way, it is possible to appropriately select whether or not the virtual color difference RGc is used in class sorting on the basis of a characteristic of a pixel forming the R class tap.

The R class tap output from the (R−G) conversion unit 155-21 is supplied to the (R−G) class sorting unit 156-2. In a case of the tap mode 1, the R class tap output from the (R−G) conversion unit 155-21 is formed by the virtual color difference RGc operated using the above Equation (14). In a case of the tap mode 0, the R class tap output from the (R−G) conversion unit 155-21 is formed by the input value R.

The (R−G) class sorting unit 156-2 codes the supplied R class tap by using adaptive dynamic range coding (ADRC) so as to generate a class code. In addition, information for specifying the tap mode selected when acquiring the R class tap is added to the class code. The class code generated here is output to the (R−G) coefficient memory 157-2.

The (R−G) coefficient memory 157-2 reads a coefficient which is stored in correlation with the class code and the tap mode output from the (R−G) class sorting unit 156-2, and supplies the read coefficient to the (R−G) product-sum operation unit 158-2. In addition, the (R−G) coefficient memory 157-2 stores a coefficient which is obtained in advance through learning and is used in a product-sum operation described later, in correlation with the class code and the tap mode.

In addition, if the image processing apparatus 150 with the configuration of FIG. 18 is used, in learning of the coefficient stored in the (R−G) coefficient memory 157-2, learning for generating the R output image is performed in cases where a class tap or a prediction tap is formed by a virtual color difference and is formed by an input value.

The R prediction tap selected by the R prediction tap selection unit 153-2 is supplied to the (R−G) conversion unit 155-22. The (R−G) conversion unit 155-22 performs a (R−G) conversion process on each pixel value forming the R prediction tap, and a virtual color difference is calculated due to the (R−G) conversion process.

A (R−G) conversion process performed by the (R−G) conversion unit 155-22 is the same as the one performed by the (R−G) conversion unit 155-21. In other words, in a case of the tap mode 1, the virtual color difference RGc is operated using the above Equation (14), and in a case of the tap mode 0, the R class tap is output to the (R−G) product-sum operation unit 158-2 as it is without performing the operation of Equation (14).

In this way, it is possible to appropriately select whether or not the virtual color difference RGc is used in a product-sum operation on the basis of a characteristic of a pixel forming the R prediction tap.

The R prediction tap output from the (R−G) conversion unit 155-22 is supplied to the (R−G) product-sum operation unit 158-2. In a case of the tap mode 1, the R prediction tap output from the (R−G) conversion unit 155-22 is formed by the virtual color difference RGc operated using the above Equation (14). In a case of the tap mode 0, the R prediction tap output from the (R−G) conversion unit 155-22 is formed by the input value R.

In a case of the tap mode 1, the (R−G) product-sum operation unit 158-2 predictively operates a color difference of (R−G) of a target pixel in an R component image (R output image) which is an output image, on the basis of the R prediction tap. On the other hand, in a case of the tap mode 0, the (R−G) product-sum operation unit 158-2 predictively operates a value of a target pixel in an R component image (R output image) which is an output image, on the basis of the R prediction tap.

In a case of the tap mode 1, the R conversion unit 159-2 converts a prediction value (R−G)p of the color difference of (R−G) of the target pixel output from the (R−G) product-sum operation unit 158-2, into a prediction value Rp of an R component pixel value, for example, through an operation of Equation (15).

Rp=(R−G)p+Gp (15)

On the other hand, in a case of the tap mode 0, the R conversion unit 159-2 outputs the value of the target pixel output from the (R−G) product-sum operation unit 158-2 as it is without performing the Equation (15).

As described above, each target pixel is predicted, thereby obtaining the R output image.

In addition, in a case of employing the configuration of FIG. 18, a tap mode for generating a B output image is selected as follows.

In a case where a tap mode is selected when generating the B output image, a threshold value Ath used in comparison of the normalized dynamic range NDR_B, and a threshold value Bth used in the color variation amount Bv are set in advance.

If NDR_B≧Ath, and Bv≧Bth, the tap mode 1 is selected. The tap mode 1 is a tap mode selected when a variation amount of a pixel value and a color variation amount of only the B component are large and variation amounts of pixel values and color variation amounts of the other color components are small in the designated region.

In a case which does not correspond to the above case, the tap mode 0 is selected.

In a case of the configuration of FIG. 18, the (B−G) conversion unit 155-31 and the (B−G) conversion unit 155-32 are controlled so as to perform or stop an operation on the basis of the tap mode.

In a case of the tap mode 1, the (B−G) conversion unit 155-31 performs a (B−G) conversion process on each pixel value forming the R class tap, and a virtual color difference is calculated due to the (B−G) conversion process. In other words, the (B−G) conversion unit 155-31 performs an operation of Equation (16) on each pixel value forming the B class tap so as to calculate a virtual color difference BGc.

BGc=B−g (16)

In addition, the interpolation value g in Equation (16) is supplied from the representative RGB operation unit 151.

On the other hand, in a case of the tap mode 0, the (B−G) conversion unit 155-31 outputs the B class tap to the (B−G) class sorting unit 156-3 as it is without performing the operation of Equation (16).

In this way, it is possible to appropriately select whether or not the virtual color difference BGc is used in class sorting on the basis of a characteristic of a pixel forming the B class tap.

The B class tap output from the (B−G) conversion unit 155-31 is supplied to the (B−G) class sorting unit 156-3. In a case of the tap mode 1, the B class tap output from the (B−G) conversion unit 155-31 is formed by the virtual color difference BGc operated using the above Equation (16). In a case of the tap mode 0, the B class tap output from the (B−G) conversion unit 155-31 is formed by the input value B.

The (B−G) class sorting unit 156-3 codes the supplied B class tap by using adaptive dynamic range coding (ADRC) so as to generate a class code. In addition, information for specifying the tap mode selected when acquiring the B class tap is added to the class code. The class code generated here is output to the (B−G) coefficient memory 157-3.

The (B−G) coefficient memory 157-3 reads a coefficient which is stored in correlation with the class code and the tap mode output from the (B−G) class sorting unit 156-3, and supplies the read coefficient to the (B−G) product-sum operation unit 158-3. In addition, the (B−G) coefficient memory 157-3 stores a coefficient which is obtained in advance through learning and is used in a product-sum operation described later, in correlation with the class code and the tap mode.

In addition, if the image processing apparatus 150 with the configuration of FIG. 18 is used, in learning of the coefficient stored in the (B−G) coefficient memory 157-3, learning for generating the B output image is performed in cases where a class tap or a prediction tap is formed by a virtual color difference and is formed by an input value.

The B prediction tap selected by the B prediction tap selection unit 153-3 is supplied to the (B−G) conversion unit 155-32. The (B−G) conversion unit 155-32 performs a (B−G) conversion process on each pixel value forming the B prediction tap, and a virtual color difference is calculated due to the (B−G) conversion process.

A (B−G) conversion process performed by the (B−G) conversion unit 155-32 is the same as the one performed by the (R−G) conversion unit 155-31. In other words, in a case of the tap mode 1, the virtual color difference BGc is operated using the above Equation (16), and in a case of the tap mode 0, the R class tap is output to the (B−G) product-sum operation unit 158-3 as it is without performing the operation of Equation (16).

In this way, it is possible to appropriately select whether or not the virtual color difference BGc is used in a product-sum operation on the basis of a characteristic of a pixel forming the B prediction tap.

The B prediction tap output from the (B−G) conversion unit 155-32 is supplied to the (B−G) product-sum operation unit 158-3. In a case of the tap mode 1, the B prediction tap output from the (B−G) conversion unit 155-32 is formed by the virtual color difference BGc operated using the above Equation (16). In a case of the tap mode 0, the B prediction tap output from the (B−G) conversion unit 155-32 is formed by the input value B.

In a case of the tap mode 1, the (B−G) product-sum operation unit 158-3 predictively operates a color difference of (B−G) of a target pixel in a B component image (B output image) which is an output image, on the basis of the B prediction tap. On the other hand, in a case of the tap mode 0, the (B−G) product-sum operation unit 158-3 predictively operates a value of a target pixel in a B component image (B output image) which is an output image, on the basis of the B prediction tap.

In a case of the tap mode 1, the B conversion unit 159-3 converts a prediction value (B−G)p of the color difference of (B−G) of the target pixel output from the (B−G) product-sum operation unit 158-3, into a prediction value Bp of a B component pixel value, for example, through an operation of Equation (17).

Bp=(B−G)p+Gp (17)

On the other hand, in a case of the tap mode 0, the B conversion unit 159-3 outputs the value of the target pixel output from the (B−G) product-sum operation unit 158-3 as it is without performing the Equation (17).

As described above, each target pixel is predicted, thereby obtaining the B output image.

In addition, when the virtual color difference is calculated, a pixel value of each color component may be multiplied by a coefficient which is a matrix coefficient stipulated in, for example, BT709, BT601, or the like, and is used when conversion is performed from RGB to Y, pb or pr. In this way, it is possible to realize a more favorable S/N ratio in an output image.

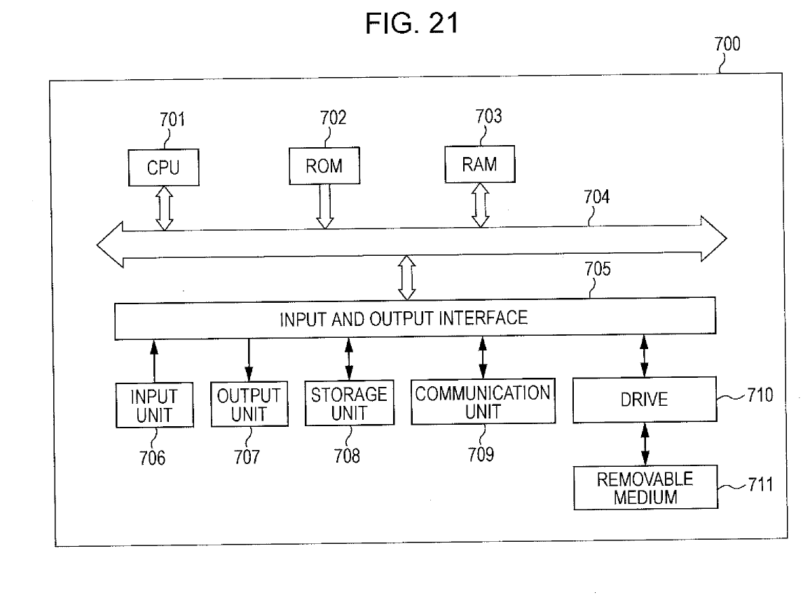

The above-described series of processes may be performed by hardware or software. When the above-described series of processes is performed by the software, programs constituting the software are installed from a network or a recording medium to a computer incorporated into dedicated hardware, or, for example, a general purpose personal computer 700 or the like as illustrated in FIG. 21 which can execute various kinds of functions by installing various kinds of programs.

In FIG. 21, a CPU (Central Processing Unit) 701 performs various processes according to a program stored in a read only memory (ROM) 702 or a program which is loaded to a random access memory (RAM) 703 from a storage unit 708. The RAM 703 appropriately stores data or the like which is necessary for the CPU 701 to execute various processes.

The CPU 701, the ROM 702, and the RAM 703 are connected to each other via a bus 704. In addition, an input and output interface 705 is also connected to the bus 704.

The input and output interface 705 is connected to an input unit 706 including a keyboard, a mouse, and the like, an output unit 707 including a display such as a liquid crystal display (LCD), a speaker, and the like, a storage unit 708 including a hard disk, or the like, and a communication unit 709 including a modem, a network interface card such as a LAN card, or the like. The communication unit 709 performs a communication process via a network including the Internet.

A drive 710 is connected to the input and output interface 705 as necessary, a removable medium 711 such as a magnetic disk, an optical disc, a magneto-optical disc, or a semiconductor memory, is appropriately installed therein, and a computer program read therefrom is installed in the storage unit 708 as necessary.

In a case where the above-described series of processes is executed in software, a program constituting the software is installed from a network such as the Internet or a recording medium including the removable medium 711.

The recording medium includes, for example, as illustrated in FIG. 21, not only the removable medium 711 such as a magnetic disk (including a floppy disk (registered trademark)), an optical disc (including a compact disc-read only memory (CD-ROM) and a digital versatile disc (DVD)), a magneto-optical disc (including a mini disc (MD)), or a semiconductor memory, which is distributed so as to deliver a program to a user separately from a device body, but also the ROM 702 which is sent to a user in a state of being incorporated into a device body and records a program therein, or a hard disk included in the storage unit 708.

In the present specification, the above-described series of processes includes not only processes performed in a time series according to the described order, but also processes performed in parallel or separately even if not necessarily performed in the time series.

In addition, embodiments of the present technology are not limited to the above-described embodiments but may have various modifications without departing from the scope of the present technology.

In addition, the present technology may have the following configurations.

(1) An image processing apparatus including: a color variation amount/normalized dynamic range operation unit that selects a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component; a class sorting unit that performs class sorting on the designated region on the basis of a feature amount obtained from pixel values of the designated region; a coefficient reading unit that reads a coefficient stored in advance on the basis of a result of the class sorting; and a product-sum operation unit that uses a prediction tap including pixel values related to predetermined pixels of the designated region for the prediction tap as a variable, and operates pixel values of second images through a product-sum operation using the read coefficient, each of the second images being formed by pixels of only a single color component of the plurality of color components, wherein an operation method of pixel values of the second image formed by pixels of only the first color component and an operation method of pixel values of the second image formed by pixels of only the second color component are changed on the basis of the color variation amounts and the normalized dynamic ranges.

(2) The image processing apparatus according to (1), wherein the a structure of the prediction tap is changed on the basis of the color variation amounts and the normalized dynamic ranges.

(3) The image processing apparatus according to (1) or (2), further including a representative value operation unit that operates a representative value of each of the color components in the designated region; and a color component conversion unit that converts pixel values of each color component of the prediction tap into conversion values which are obtained by offsetting the pixel values with respect to a pixel value of one of the plurality of color components, serving as a reference, by using the representative value, wherein the product-sum operation unit uses the conversion values as variables, and operates pixel values of second images through a product-sum operation using the read coefficient, each of the second images being formed by pixels of only a single color component of the plurality of color components.

(4) The image processing apparatus according to (3), wherein the single-plate type pixel portion is a pixel portion with a Bayer array including R, G and B components, and wherein the representative value operation unit calculates an interpolation value g of an R pixel or a B pixel on the basis of a G pixel around the R pixel or the B pixel; calculates an interpolation value r and an interpolation value b of the G pixel on the basis of the R pixel or the B pixel around the G pixel; operates a G representative value by using an average value of an input value G which is directly obtained from the G pixel and the interpolation value g; operates an R representative value on the basis of a difference between the interpolation value r and the input value G, a difference between an input value R which is directly obtained from the R pixel and the interpolation value g, and the G representative value; and operates a B representative value on the basis of a difference between the interpolation value b and the input value G, a difference between an input value B which is directly obtained from the B pixel and the interpolation value g, and the G representative value.

(5) The image processing apparatus (4), wherein, when the second image is formed by only the G pixel, the color component conversion unit offsets the input value R by a difference between the R representative value and the G representative value, and offsets the input value B by a difference between the B representative value and the G representative value.

(6) The image processing apparatus according to (4), wherein the color variation amount/normalized dynamic range operation unit calculates a color variation amount Rv of an R component on the basis of a dynamic range of a difference value between the input value R and the interpolation value g of the R pixel; calculates a color variation amount Bv of a B component on the basis of a dynamic range of a difference value between the input value B and the interpolation value g of the B pixel; normalizes a dynamic range of the input value R so as to calculate a normalized dynamic range NDR_R of the R component; normalizes a dynamic range of the input value B so as to calculate a normalized dynamic range NDR_B of the B component; and normalizes a dynamic range of the input value G so as to calculate a normalized dynamic range NDR_G of a G component.

(7) The image processing apparatus according to (6), wherein, when the second image formed by only the G component of the plurality of color components, and the second image formed by only the R component and the second image formed by only the B component of the plurality of color components, the prediction tap is acquired from the second image formed by only the G component.

(8) The image processing apparatus according to (7), wherein, when the second image formed by only the R component is generated, any one of first to third modes is selected by comparing the color variation amount Rv, the normalized dynamic range NDR_R, the normalized dynamic range NDR_G, and an absolute value of a difference value between the color variation amount Rv and the color variation amount Bv with threshold values, respectively, wherein, in the first mode, a prediction tap including the input value R of the first image and pixel values of the second image formed by pixels of only the G component is acquired, wherein, in the second mode, a prediction tap including only pixel values of the second image formed by pixels of only the G component is acquired, and wherein, in the third mode, a prediction tap including only the input value R of the first image is acquired.

(9) The image processing apparatus according to any one of (1) to (8), further including a virtual color difference operation unit that operates a virtual color difference of the prediction tap, wherein, when the second image formed by only the first color component or the second color component of the plurality of color components is generated, the product-sum operation unit uses a virtual color difference of the prediction tap as a variable and operates a virtual color difference of the second image through a product-sum operation using the read coefficient, and the prediction tap formed by only a pixel corresponding to the first color component or the second color component is acquired from the designated region of the first image.

(10) The image processing apparatus according to (9), wherein the virtual color difference operation unit is controlled to perform or stop an operation on the basis of the color variation amounts and the normalized dynamic ranges.

(11) The image processing apparatus according to (9) or (10), wherein the virtual color difference operation unit operates the virtual color difference by multiplying a value of the pixel forming the prediction tap by a matrix coefficient stipulated in a color space standard.

(12) The image processing apparatus according to (3), further including another color component conversion unit that converts pixel values of each color component of a class tap into conversion values which are obtained by offsetting the pixel values of the first color component with respect to a pixel value of one of the plurality of color components serving as a reference by using the representative value, the class tap including pixel values related to predetermined pixels of the designated region, wherein the class sorting unit determines a feature amount of the class tap on the basis of the conversion values obtained by another color component conversion unit.

(13) The image processing apparatus according to any one of (1) to (12), wherein the coefficient read by the coefficient reading unit is obtained in advance through learning, and wherein, in the learning, images, which are formed by image signals output from a plurality of pixel portions each of which includes pixels of only a single color component of the plurality of color components, are used as teacher images, the pixel portions being disposed at a position closer to a subject than an optical low-pass filter disposed between the single-plate type pixel portion and the subject; an image formed by the image signals output from the single-plate type pixel portion is used as a student image; and the coefficient is calculated by solving a normal equation which maps the pixel of the student image and the pixel of the teacher image to each other.

(14) An image processing method including: causing a color variation amount/normalized dynamic range operation unit to select a designated region which is a region including a predetermined number of pixels, from a first image formed by image signals which are output from a single-plate type pixel portion where pixels respectively corresponding to a plurality of color components are regularly disposed on a plane, and operate color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component; causing a class sorting unit to perform class sorting on the designated region on the basis of a feature amount obtained from pixel values of the designated region; causing a coefficient reading unit to read a coefficient stored in advance on the basis of a result of the class sorting; and causing a product-sum operation unit to use a prediction tap including pixel values related to predetermined pixels of the designated region for the prediction tap as a variable, and operate pixel values of second images through a product-sum operation using the read coefficient, each of the second images being formed by pixels of only a single color component of the plurality of color components, wherein an operation method of pixel values of the second image formed by pixels of only the first color component and an operation method of pixel values of the second image formed by pixels of only the second color component are changed on the basis of the color variation amounts and the normalized dynamic ranges.

(15) A program causing a computer to function as an image processing apparatus including: a color variation amount/normalized dynamic range operation unit that selects a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component; a class sorting unit that performs class sorting on the designated region on the basis of a feature amount obtained from pixel values of the designated region; a coefficient reading unit that reads a coefficient stored in advance on the basis of a result of the class sorting; and a product-sum operation unit that uses a prediction tap including pixel values related to predetermined pixels of the designated region for the prediction tap as a variable, and operates pixel values of second images through a product-sum operation using the read coefficient, each of the second images being formed by pixels of only a single color component of the plurality of color components, wherein an operation method of pixel values of the second image formed by pixels of only the first color component and an operation method of pixel values of the second image formed by pixels of only the second color component are changed on the basis of the color variation amounts and the normalized dynamic ranges.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a color variation amount/normalized dynamic range operation unit that selects a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component;
a class sorting unit that performs class sorting on the designated region on the basis of a feature amount obtained from pixel values of the designated region;
a coefficient reading unit that reads a coefficient stored in advance on the basis of a result of the class sorting; and
a product-sum operation unit that uses a prediction tap including pixel values related to predetermined pixels of the designated region for the prediction tap as a variable, and operates pixel values of second images through a product-sum operation using the read coefficient, each of the second images being formed by pixels of only a single color component of the plurality of color components,
wherein an operation method of pixel values of the second image formed by pixels of only the first color component and an operation method of pixel values of the second image formed by pixels of only the second color component are changed on the basis of the color variation amounts and the normalized dynamic ranges.

2. The image processing apparatus according to claim 1, wherein a structure of the prediction tap is changed on the basis of the color variation amounts and the normalized dynamic ranges.

3. The image processing apparatus according to claim 1, further comprising:
a representative value operation unit that operates a representative value of each of the color components in the designated region; and
a color component conversion unit that converts pixel values of each color component of the prediction tap into conversion values which are obtained by offsetting the pixel values with respect to a pixel value of one of the plurality of color components, serving as a reference, by using the representative value,
wherein the product-sum operation unit uses the conversion values as variables, and operates pixel values of second images through a product-sum operation using the read coefficient, each of the second images being formed by pixels of only a single color component of the plurality of color components.

4. The image processing apparatus according to claim 3,
wherein the single-plate type pixel portion is a pixel portion with a Bayer array including R, G and B components, and
wherein the representative value operation unit
calculates an interpolation value g of an R pixel or a B pixel on the basis of a G pixel around the R pixel or the B pixel;
calculates an interpolation value r and an interpolation value b of the G pixel on the basis of the R pixel or the B pixel around the G pixel;
operates a G representative value by using an average value of an input value G which is directly obtained from the G pixel and the interpolation value g;
operates an R representative value on the basis of a difference between the interpolation value r and the input value G, a difference between an input value R which is directly obtained from the R pixel and the interpolation value g, and the G representative value; and
operates a B representative value on the basis of a difference between the interpolation value b and the input value G, a difference between an input value B which is directly obtained from the B pixel and the interpolation value g, and the G representative value.

5. The image processing apparatus according to claim 4,
wherein, when the second image is formed by only the G pixel, the color component conversion unit offsets the input value R by a difference between the R representative value and the G representative value, and offsets the input value B by a difference between the B representative value and the G representative value.

6. The image processing apparatus according to claim 4,
wherein the color variation amount/normalized dynamic range operation unit
calculates a color variation amount Rv of an R component on the basis of a dynamic range of a difference value between the input value R and the interpolation value g of the R pixel;
calculates a color variation amount Bv of a B component on the basis of a dynamic range of a difference value between the input value B and the interpolation value g of the B pixel;
normalizes a dynamic range of the input value R so as to calculate a normalized dynamic range NDR_R of the R component;
normalizes a dynamic range of the input value B so as to calculate a normalized dynamic range NDR_B of the B component; and
normalizes a dynamic range of the input value G so as to calculate a normalized dynamic range NDR_G of a G component.

7. The image processing apparatus according to claim 6, wherein, when the second image formed by only the G component of the plurality of color components is generated, and the second image formed by only the R component and the second image formed by only the B component of the plurality of color components are generated, the prediction tap is acquired from the second image formed by only the G component.

8. The image processing apparatus according to claim 7, wherein, when the second image formed by only the R component is generated, any one of first to third modes is selected by comparing the color variation amount Rv, the normalized dynamic range NDR_R, the normalized dynamic range NDR_G, and an absolute value of a difference value between the color variation amount Rv and the color variation amount Bv with threshold values, respectively,
wherein, in the first mode, a prediction tap including the input value R of the first image and pixel values of the second image formed by pixels of only the G component is acquired,
wherein, in the second mode, a prediction tap including only pixel values of the second image formed by pixels of only the G component is acquired, and
wherein, in the third mode, a prediction tap including only the input value R of the first image is acquired.

9. The image processing apparatus according to claim 1, further comprising:
a virtual color difference operation unit that operates a virtual color difference of the prediction tap,
wherein, when the second image formed by only the first color component or the second color component of the plurality of color components is generated, the product-sum operation unit uses a virtual color difference of the prediction tap as a variable and operates a virtual color difference of the second image through a product-sum operation using the read coefficient, and the prediction tap formed by only a pixel corresponding to the first color component or the second color component is acquired from the designated region of the first image.

10. The image processing apparatus according to claim 9, wherein the virtual color difference operation unit is controlled to perform or stop an operation on the basis of the color variation amounts and the normalized dynamic ranges.

11. The image processing apparatus according to claim 9, wherein the virtual color difference operation unit operates the virtual color difference by multiplying a value of the pixel forming the prediction tap by a matrix coefficient stipulated in a color space standard.

12. The image processing apparatus according to claim 3, further comprising:
another color component conversion unit that converts pixel values of each color component of a class tap into conversion values which are obtained by offsetting the pixel values with respect to a pixel value of one of the plurality of color components serving as a reference by using the representative value, the class tap including pixel values related to predetermined pixels of the designated region for the class tap,
wherein the class sorting unit determines a feature amount of the class tap on the basis of the conversion values obtained by another color component conversion unit.

13. The image processing apparatus according to claim 1,
wherein the coefficient read by the coefficient reading unit is obtained in advance through learning, and
wherein, in the learning,
images, which are formed by image signals output from a plurality of pixel portions each of which includes pixels of only a single color component of the plurality of color components, are used as teacher images, the pixel portions being disposed at a position closer to a subject than an optical low-pass filter disposed between the single-plate type pixel portion and the subject;
an image formed by the image signals output from the single-plate type pixel portion is used as a student image; and
the coefficient is calculated by solving a normal equation which maps the pixel of the student image and the pixel of the teacher image to each other.

14. An image processing method comprising:
causing a color variation amount/normalized dynamic range operation unit to select a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component;
causing a class sorting unit to perform class sorting on the designated region on the basis of a feature amount obtained from pixel values of the designated region;
causing a coefficient reading unit to read a coefficient stored in advance on the basis of a result of the class sorting; and
causing a product-sum operation unit to use a prediction tap including pixel values related to predetermined pixels of the designated region for the prediction tap as a variable, and operates pixel values of second images through a product-sum operation using the read coefficient, each of the second images being formed by pixels of only a single color component of the plurality of color components,
wherein an operation method of pixel values of the second image formed by pixels of only the first color component and an operation method of pixel values of the second image formed by pixels of only the second color component are changed on the basis of the color variation amounts and the normalized dynamic ranges.

15. A program causing a computer to function as an image processing apparatus comprising:
a color variation amount/normalized dynamic range operation unit that selects a designated region which is a region including a predetermined number of pixels, from a first image formed by image signals which are output from a single-plate type pixel portion where pixels respectively corresponding to a plurality of color components are regularly disposed on a plane, and operates color variation amounts indicating variation amounts of a first color component and a second color component for a third color component of the plurality of color components in pixels of the designated region, and normalized dynamic ranges obtained by normalizing dynamic ranges of a pixel value of the first color component and a pixel value of the second color component;
a class sorting unit that performs class sorting on the designated region on the basis of a feature amount obtained from pixel values of the designated region;
a coefficient reading unit that reads a coefficient stored in advance on the basis of a result of the class sorting; and
a product-sum operation unit that uses a prediction tap including pixel values related to predetermined pixels of the designated region for the prediction tap as a variable, and operates pixel values of second images through a product-sum operation using the read coefficient, each of the second images being formed by pixels of only a single color component of the plurality of color components,
wherein an operation method of pixel values of the second image formed by pixels of only the first color component and an operation method of pixel values of the second image formed by pixels of only the second color component are changed on the basis of the color variation amounts and the normalized dynamic ranges.
